(19) United States
(12) Patent Application Publication
(10) Pub. No.: US 2011/0011378 A1
(43) Pub. Date: Jan. 20, 2011

(54) ABNORMALITY DIAGNOSIS APPARATUS FOR EXHAUST GAS RECIRCULATION APPARATUS AND ABNORMALITY DIAGNOSIS METHOD FOR EXHAUST GAS RECIRCULATION APPARATUS

(75) Inventor: Takashi Nakamura, Aichi-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOYOTA JIDOSHA KABUSHIKI KAISHA, Toyota-shi, Aichi-ken (JP)

(21) Appl. No.: 12/935,142

(22) PCT Filed: Mar. 19, 2009
(86) PCT No.: PCT/IB2009/000585

§ 371 Date: Sep. 28, 2010

(30) Foreign Application Priority Data
Mar. 28, 2008 (JP) 2008-087480

(51) Int. Cl. F02M 25/07

(52) U.S. Cl. 123/568.16

(57) ABSTRACT

An EGR apparatus includes an EGR passage that connects an intake passage and an exhaust passage of an internal combustion engine in order to introduce a part of an exhaust gas into the intake passage, and an EGR valve for adjusting the amount of exhaust gas flowing through the passage. An oxygen concentration sensor that outputs a continuous value corresponding to the oxygen concentration of the exhaust gas flowing through the exhaust passage is provided in the exhaust passage. Valve-opening driving is performed on the EGR valve during fuel cut processing for halting the fuel supply of the internal combustion engine, and when a variation range of the output value of the oxygen concentration sensor accompanying the valve-opening driving is smaller than a predetermined value, it is determined that an abnormality is present in the EGR apparatus.

### BACKGROUND OF THE INVENTION

1. Field of the Invention

The invention relates to an abnormality diagnosis apparatus and an abnormality diagnosis method for an exhaust gas recirculation apparatus.

2. Description of the Related Art

An example of an internal combustion engine, an exhaust gas recirculation apparatus (EGR apparatus) is provided to recirculate a part of the exhaust gas to an intake passage. The EGR apparatus includes an exhaust gas recirculation passage (EGR passage) that connects the intake passage and an exhaust passage of the internal combustion engine in order to introduce a part of the exhaust gas into the intake passage, and an exhaust gas amount control valve (EGR valve) that adjusts the amount of exhaust gas flowing through the EGR passage. By adjusting the opening of the EGR valve, the amount of exhaust gas introduced into the intake passage is adjusted. Hence, exhaust gas is introduced into the intake passage and supplied to a combustion chamber in an appropriate amount for the engine operating conditions, thereby reducing the combustion temperature, and as a result, the amount of discharged nitrogen oxides (NOx) can be suppressed.

When an abnormality such as an operation defect of the EGR valve or blockage of the EGR passage occurs in this type of EGR apparatus, it becomes difficult to adjust the amount of exhaust gas introduced into the intake passage to an appropriate amount for the engine operating conditions. Therefore, various constitutions have been proposed for executing an abnormality diagnosis on the EGR apparatus during an operation of the internal combustion engine to determine whether an abnormality has occurred in the EGR apparatus.

However, when the opening of the EGR valve is varied in order to execute the abnormality diagnosis, the amount of exhaust gas supplied to the combustion chamber varies accordingly, and as a result, the combustion condition may deteriorate. Hence, a constitution has been proposed for executing the abnormality diagnosis during fuel cut processing, in which the fuel supply is stopped in a predetermined low speed region, in order to suppress deterioration of the combustion condition during execution of the diagnosis. For example, a constitution described in Japanese Patent Application Publication No. 7-180615 (JP-A-7-180615) executes an abnormality diagnosis on an EGR valve during fuel cut processing by opening and closing the EGR valve to detect variation in an internal pressure of the intake passage.

To execute an abnormality diagnosis on the EGR valve, the constitution described in JP-A-7-180615 is provided with a dedicated sensor for detecting the internal pressure of the intake passage. However, providing this type of dedicated sensor may lead to an increase in manufacturing cost. Moreover, a further abnormality diagnosis is preferably performed on the dedicated sensor to ensure that the abnormality diagnosis of the EGR valve is precise, and this may lead to an increase in the processing load required to execute the abnormality diagnosis.

### SUMMARY OF THE INVENTION

The invention provides an abnormality diagnosis apparatus for an exhaust gas recirculation apparatus and an abnormality diagnosis method for an exhaust gas recirculation apparatus with which an abnormality in the exhaust gas recirculation apparatus can be determined accurately without providing a dedicated sensor for determining the abnormality in the apparatus.

A first aspect of the invention relates to an abnormality diagnosis apparatus applied to an exhaust gas recirculation apparatus. The exhaust gas recirculation apparatus includes an exhaust gas recirculation passage that connects an intake passage and an exhaust passage of an internal combustion engine in order to introduce a part of an exhaust gas into the intake passage, and an exhaust gas amount control valve that adjusts an amount of the exhaust gas flowing through the exhaust gas recirculation passage. The abnormality diagnosis apparatus includes: an oxygen concentration sensor that is provided in the exhaust passage and outputs a continuous value corresponding to an oxygen concentration of the exhaust gas flowing through the exhaust passage; and an EGR abnormality diagnosis unit that performs valve-opening driving on the exhaust gas amount control valve during fuel cut processing for halting a fuel supply of the internal combustion engine, and executes abnormality diagnosis processing for determining that an abnormality is present in the exhaust gas recirculation apparatus when a variation range of an output value the oxygen concentration sensor accompanying the valve-opening driving is smaller than a predetermined value.

The oxygen concentration sensor that outputs the continuous value corresponding to the oxygen concentration of the exhaust gas flowing through the exhaust passage of the internal combustion engine is provided in the exhaust passage, and an air-fuel ratio of an air-fuel mixture in a combustion chamber is controlled on the basis of the output value of the sensor to converge on a target air-fuel ratio.

When the fuel cut processing for halting the fuel supply of the internal combustion engine is executed, the oxygen concentration in the exhaust passage is raised by air supplied through the intake passage, and therefore the output value of the oxygen concentration sensor varies to a lean side. When the exhaust gas amount control valve is opened during the fuel cut processing, the exhaust gas that has accumulated in the exhaust gas recirculation passage flows into the combustion chamber as the valve is opened, and therefore the oxygen concentration of the exhaust passage decreases temporarily, causing the output value of the oxygen concentration sensor to vary to a rich side. Meanwhile, when an abnormality occurs in the exhaust gas recirculation apparatus, flow rate variation in the exhaust gas recirculation passage following opening of the exhaust gas amount control valve falls below an expected flow rate variation, and as a result, the amount of variation in the oxygen concentration of the exhaust passage decreases. Note that in this specification, the phrase “the output value of the oxygen concentration sensor varies to a lean side” may be used to mean “the air-fuel ratio of the air-fuel mixture in the combustion chamber, which is based on the output value of the oxygen concentration sensor, varies to the lean side”. Further, the phrase “the output value of the oxygen concentration sensor varies to a rich side” may be used to mean “the air-fuel ratio of the air-fuel mixture in the combustion chamber, which is based on the output value of the oxygen concentration sensor, varies to the rich side”.

According to the abnormality diagnosis apparatus of the first aspect of the invention, valve-opening driving can be performed on the exhaust gas amount control valve during execution of the fuel cut processing for halting the fuel supply of the internal combustion engine, and the presence of an abnormality in the exhaust gas recirculation apparatus can be determined when the variation range of the output value of the oxygen concentration sensor accompanying the valve-opening driving is smaller than the predetermined value. Therefore, the presence of an abnormality in the exhaust gas recirculation apparatus can be determined accurately without providing a dedicated sensor for determining the presence of an abnormality in the apparatus. Further, the presence of an abnormality in the apparatus is determined during execution of the fuel cut processing, and therefore deterioration of the combustion condition in the combustion chamber accompanying opening of the exhaust gas amount control valve can be suppressed.

A second aspect of the invention relates to an abnormality diagnosis apparatus applied to an exhaust gas recirculation apparatus. The exhaust gas recirculation apparatus includes an exhaust gas recirculation passage that connects an intake passage and an exhaust passage of an internal combustion engine in order to introduce a part of an exhaust gas into the intake passage, and an exhaust gas amount control valve that adjusts an amount of the exhaust gas flowing through the exhaust gas recirculation passage. The abnormality diagnosis apparatus includes: an oxygen concentration sensor that is provided in the exhaust passage and outputs a continuous value corresponding to an oxygen concentration of the exhaust gas flowing through the exhaust passage; and an EGR abnormality diagnosis unit that performs valve-opening driving on the exhaust gas amount control valve during fuel cut processing for halting a fuel supply of the internal combustion engine, and executes abnormality diagnosis processing for determining that an abnormality is present in the exhaust gas recirculation apparatus when a deviation between an output value of the oxygen concentration sensor following the valve-opening driving and a determination value equals or exceeds a predetermined value.

As described above, when the exhaust gas amount control valve is opened during the fuel cut processing, the exhaust gas that has accumulated in the exhaust gas recirculation passage flows into the combustion chamber as the valve is opened, and therefore the oxygen concentration of the exhaust passage decreases temporarily, causing the output value of the oxygen concentration sensor to vary to a rich side. Meanwhile, when an abnormality occurs in the exhaust gas recirculation apparatus, flow rate variation in the exhaust gas recirculation passage following opening of the exhaust gas amount control valve diverges from the expected flow rate variation, and as a result, the amount of variation in the oxygen concentration of the exhaust passage following opening of the control valve diverges from an expected amount of variation. Accordingly, the output value of the oxygen concentration sensor diverges from an expected output value (the determination value).

According to the abnormality diagnosis apparatus of the second aspect of the invention, valve-opening driving can be performed on the exhaust gas amount control valve during execution of the fuel cut processing for halting the fuel supply of the internal combustion engine, and the presence of an abnormality in the exhaust gas recirculation apparatus can be determined when the deviation between the output value of the oxygen concentration sensor following the valve-opening driving and the determination value equals or exceeds the predetermined value. Therefore, the presence of an abnormality in the exhaust gas recirculation apparatus can be determined accurately without providing a dedicated sensor for determining the presence of an abnormality in the apparatus. Further, the presence of an abnormality in the apparatus is determined during execution of the fuel cut processing, and therefore deterioration of the combustion condition in the combustion chamber accompanying opening of the exhaust gas amount control valve can be suppressed.

Note that the determination value is set in advance on the basis of a theoretical value or an experimental value, taking into consideration the volume of the exhaust gas recirculation passage, the response speed of the exhaust gas amount control valve, variation caused by the engine operating conditions, and so on. In the abnormality diagnosis apparatus for an exhaust gas recirculation apparatus according to each of the aspects described above, the EGR abnormality diagnosis unit may perform the valve-opening driving on the exhaust gas amount control valve on condition that respective interiors of a combustion chamber and the exhaust passage of the internal combustion engine have been filled with air.

When the respective interiors of the combustion chamber and the exhaust passage are filled with air that is supplied through the intake passage during the fuel cut processing, the output value of the oxygen concentration sensor stabilizes at a lean side value. According to the constitution described above, the EGR abnormality diagnosis unit performs the valve-opening driving on the exhaust gas amount control valve on condition that the respective interiors of the combustion chamber and the exhaust passage of the internal combustion engine have been filled with air. In other words, the exhaust gas amount control valve is opened when the output value of the oxygen concentration sensor has stabilized at a lean side value, and therefore a situation in which the output value of the oxygen concentration sensor varies to the rich side when the exhaust gas amount control valve is opened can be detected easily.

Note that a state in which the respective interiors of the combustion chamber and the exhaust passage of the internal combustion engine have been filled with air may be determined in accordance with the elapse of a preset time period, an integrated value of an intake air amount, the engine rotation speed, and so on. More specifically, these values are set in advance on the basis of a theoretical value or an experimental value, taking into consideration the respective volumes of the combustion chamber, intake passage, and exhaust passage, variation caused by the engine operating conditions, and so on.

The abnormality diagnosis unit may determine that the respective interiors of the combustion chamber and the exhaust passage have been filled with air in accordance with an operating condition of the internal combustion engine.

The abnormality diagnosis unit may use an engine rotation speed as the operating condition of the internal combustion engine.

In the abnormality diagnosis apparatus for an exhaust gas recirculation apparatus, the EGR abnormality diagnosis unit may determine that an abnormality is present in the exhaust gas recirculation apparatus on the basis of the output value of the oxygen concentration sensor following the elapse of a predetermined time period from the start of the valve-opening driving performed on the exhaust gas amount control valve.

The predetermined time period is a period required for the exhaust gas that has accumulated in the exhaust gas recirculation passage to reach the oxygen concentration sensor when the valve-opening driving is executed on the exhaust gas amount control valve, and is set in advance on the basis of a theoretical value or an experimental value, taking into consideration the volume and length of the exhaust gas recirculation passage, the response speed of the exhaust gas amount control valve, the respective volumes of the combustion chamber and the exhaust passage, the engine rotation speed, and so on.

In the abnormality diagnosis apparatus for an exhaust gas recirculation apparatus, the EGR abnormality diagnosis unit may determine that an operation defect has occurred in the exhaust gas amount control valve as the abnormality in the exhaust gas recirculation apparatus.

When an operation defect occurs in the exhaust gas amount control valve, the control valve is not driven normally following the execution of valve-opening driving on the control valve, and therefore variation in the flow rate of the exhaust gas recirculation passage no longer occurs.

Therefore, the EGR abnormality diagnosis unit can determine that an operation defect has occurred in the exhaust gas amount control valve as the abnormality in the exhaust gas recirculation apparatus.

The abnormality diagnosis apparatus for an exhaust gas recirculation apparatus may further include: a sensor abnormality diagnosis unit that executes abnormality diagnosis processing for determining that an abnormality is present in the oxygen concentration sensor on the basis of the output value of the oxygen concentration sensor during the fuel cut processing; and an abnormality diagnosis selection unit that selects one of the abnormality diagnosis processing performed by the EGR abnormality diagnosis unit and the abnormality diagnosis processing performed by the sensor abnormality diagnosis unit.

Incidentally, to avoid situations in which various types of control executed on the basis of the output value of the oxygen concentration sensor cannot be executed appropriately due to an abnormality in the sensor, various constitutions have been proposed to execute abnormality diagnosis processing on the sensor during fuel cut processing, in which the sensor output is not affected by combustion in the combustion chamber. However, when abnormality diagnosis processing is executed by the EGR abnormality diagnosis unit described above during the execution of abnormality diagnosis processing on the oxygen concentration sensor, the output value of the oxygen concentration sensor varies when the exhaust gas amount control valve is opened in accordance with the abnormality diagnosis processing, and as a result, the precision of the sensor abnormality diagnosis may decrease.

According to the constitution described above, the abnormality diagnosis selection unit is provided to select one of the abnormality diagnosis processing performed by the EGR abnormality diagnosis unit and the abnormality diagnosis processing performed by the sensor abnormality diagnosis unit, and therefore a situation in which the abnormality diagnosis processes are executed simultaneously can be avoided, whereby reductions in the precision of the abnormality diagnosis performed on the oxygen concentration sensor can be suppressed.

As described above, the oxygen concentration sensor is used in other types of control, such as air-fuel ratio control, as well as the abnormality diagnosis processing performed on the exhaust gas recirculation apparatus by the EGR abnormality diagnosis unit. Therefore, even when this constitution is applied to the abnormality diagnosis apparatus for an exhaust gas recirculation apparatus described above, the processing load does not increase, and a reduction in the precision of the abnormality diagnosis performed on the exhaust gas recirculation apparatus caused by an abnormality in the sensor can be suppressed.

The abnormality diagnosis selection unit may set an order of precedence in relation to the abnormality diagnosis processing performed by the EGR abnormality diagnosis unit and the abnormality diagnosis processing performed by the sensor abnormality diagnosis unit, determine establishment of an execution condition of the abnormality diagnosis processing in accordance with the order of precedence, and permit execution of the abnormality diagnosis processing for which the execution condition is established.

In the abnormality diagnosis apparatus for an exhaust gas recirculation apparatus, when the execution condition of the abnormality diagnosis processing having a higher order of precedence is established while the other abnormality diagnosis processing is underway, the abnormality diagnosis selection unit may stop the abnormality diagnosis processing.

According to this constitution, when the execution condition of the abnormality diagnosis processing having the higher order of precedence is established while the other abnormality diagnosis' processing is underway, the abnormality diagnosis selection unit stops the abnormality diagnosis processing, and as a result, the abnormality diagnosis processing having the higher order of precedence can be executed earlier.

In the abnormality diagnosis apparatus for an exhaust gas recirculation apparatus, the abnormality diagnosis selection unit may set the order of precedence of the abnormality diagnosis processing performed by the sensor abnormality diagnosis unit to be higher than the order of precedence of the abnormality diagnosis processing performed by the EGR abnormality diagnosis unit.

According to this constitution, the abnormality diagnosis selection unit sets the order of precedence of the abnormality diagnosis processing performed by the sensor abnormality diagnosis unit to be higher than the order of precedence of the abnormality diagnosis processing performed by the EGR abnormality diagnosis unit, and therefore, an abnormality in the oxygen concentration sensor, which is used in various types of control including the abnormality diagnosis processing performed on the exhaust gas recirculation apparatus by the EGR abnormality diagnosis unit, can be determined preferentially.

In the abnormality diagnosis apparatus for an exhaust gas recirculation apparatus, when the abnormality diagnosis processing performed by the EGR abnormality diagnosis unit is executed first during a period extending from the start to the completion of the fuel cut processing, the abnormality diagnosis selection unit may permit the abnormality diagnosis processing performed by the sensor abnormality diagnosis unit after a predetermined time period has elapsed following stoppage of the abnormality diagnosis.

When the abnormality diagnosis processing performed by the sensor abnormality diagnosis unit is executed immediately after executing the abnormality diagnosis processing performed by the EGR abnormality diagnosis unit, the precision of the abnormality diagnosis performed on the oxygen concentration sensor may decrease due to the effect of variation in the output value of the oxygen concentration sensor accompanying valve-opening driving of the exhaust gas amount control valve.

According to the above constitution, when the abnormality diagnosis processing performed by the EGR abnormality diagnosis unit is executed first during a period extending from the start to the completion of the fuel cut processing, the abnormality diagnosis selection unit permits the abnormality diagnosis processing performed by the sensor abnormality diagnosis unit after a predetermined time period has elapsed following stoppage of the abnormality diagnosis, and therefore, effects on the output value of the oxygen concentration sensor from the abnormality diagnosis processing performed by the EGR abnormality diagnosis unit can be suppressed, whereby a reduction in the precision of the abnormality diagnosis performed by the sensor abnormality diagnosis unit can be suppressed.

Note that the predetermined time period is a period during which variation in the output value of the oxygen concentration sensor accompanying valve-opening driving of the exhaust gas amount control valve decreases sufficiently, and is set in advance on the basis of a theoretical value or an experimental value, taking into consideration the volume and length of the exhaust gas recirculation passage, the response speed of the exhaust gas amount control valve, the respective volumes of the combustion chamber and the exhaust passage, the engine rotation speed, and so on.

A third aspect of the invention relates to an abnormality diagnosis method for an exhaust gas recirculation apparatus. The exhaust gas recirculation apparatus includes an exhaust gas recirculation passage that connects an intake passage and an exhaust passage of an internal combustion engine in order to introduce a part of an exhaust gas into the intake passage, and an exhaust gas amount control valve that adjusts an amount of the exhaust gas flowing through the exhaust gas recirculation passage. The abnormality diagnosis method includes: outputting a continuous value corresponding to an oxygen concentration of the exhaust gas flowing through the exhaust passage; and performing valve-opening driving on the exhaust gas amount control valve during fuel cut processing for halting a fuel supply of the internal combustion engine, and determining that an abnormality is present in the exhaust gas recirculation apparatus when a variation range of an output value corresponding to the oxygen concentration of the exhaust gas flowing through the exhaust passage during the valve-opening driving is smaller than a predetermined value.

A fourth aspect of the invention relates to an abnormality diagnosis method for an exhaust gas recirculation apparatus. The exhaust gas recirculation apparatus includes an exhaust gas recirculation passage that connects an intake passage and an exhaust passage of an internal combustion engine in order to introduce a part of an exhaust gas into the intake passage, and an exhaust gas amount control valve that adjusts an amount of the exhaust gas flowing through the exhaust gas recirculation passage. The abnormality diagnosis method includes: outputting a continuous value corresponding to an oxygen concentration of the exhaust gas flowing through the exhaust passage; and performing valve-opening driving on the exhaust gas amount control valve during fuel cut processing for halting a fuel supply of the internal combustion engine, and determining that an abnormality is present in the exhaust gas recirculation apparatus when a deviation between an output value corresponding to the oxygen concentration of the exhaust gas flowing through the exhaust passage following the valve-opening driving and an expected value corresponding to an expected oxygen concentration following the elapse of a predetermined time period from the start of the fuel cut processing equals or exceeds a predetermined value.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a schematic constitutional diagram showing a constitution of an abnormality diagnosis apparatus for an exhaust gas recirculation apparatus according to the invention;

FIG. 2 is a flowchart showing a processing procedure of an “EGR abnormality diagnosis routine” according to a first embodiment;

FIG. 3 is a timing chart showing an example of an execution form of the “EGR abnormality diagnosis routine” according to the first embodiment;

FIG. 4 is a flowchart showing a processing procedure of an “abnormality diagnosis selection routine” according to a second embodiment;

FIG. 5 is a flowchart showing a processing procedure of an “EGR abnormality diagnosis routine” according to the second embodiment;

FIG. 6 is a flowchart showing a processing procedure of a “sensor abnormality diagnosis routine” according to the second embodiment;

FIG. 7 is a flowchart showing a processing procedure of an “abnormality diagnosis selection routine” according to a third embodiment;

FIG. 8, similarly to FIG. 7, is a flowchart showing the processing procedure of the “abnormality diagnosis routine” according to the third embodiment;

FIG. 9 is a flowchart showing a processing procedure of an “abnormality diagnosis selection routine” according to a fourth embodiment;

FIG. 10 is a flowchart showing a processing procedure of an “abnormality diagnosis selection routine” according to a fifth embodiment;

FIG. 11 is a flowchart showing a processing procedure of an “abnormality diagnosis selection routine” according to a sixth embodiment;

FIG. 12 is a schematic constitutional diagram showing a constitution of an abnormality diagnosis apparatus for an exhaust gas recirculation apparatus according to a seventh embodiment; and

FIG. 13 is a flowchart showing a processing procedure of an “EGR abnormality diagnosis routine” according to the seventh embodiment.

### DETAILED DESCRIPTION OF EMBODIMENTS

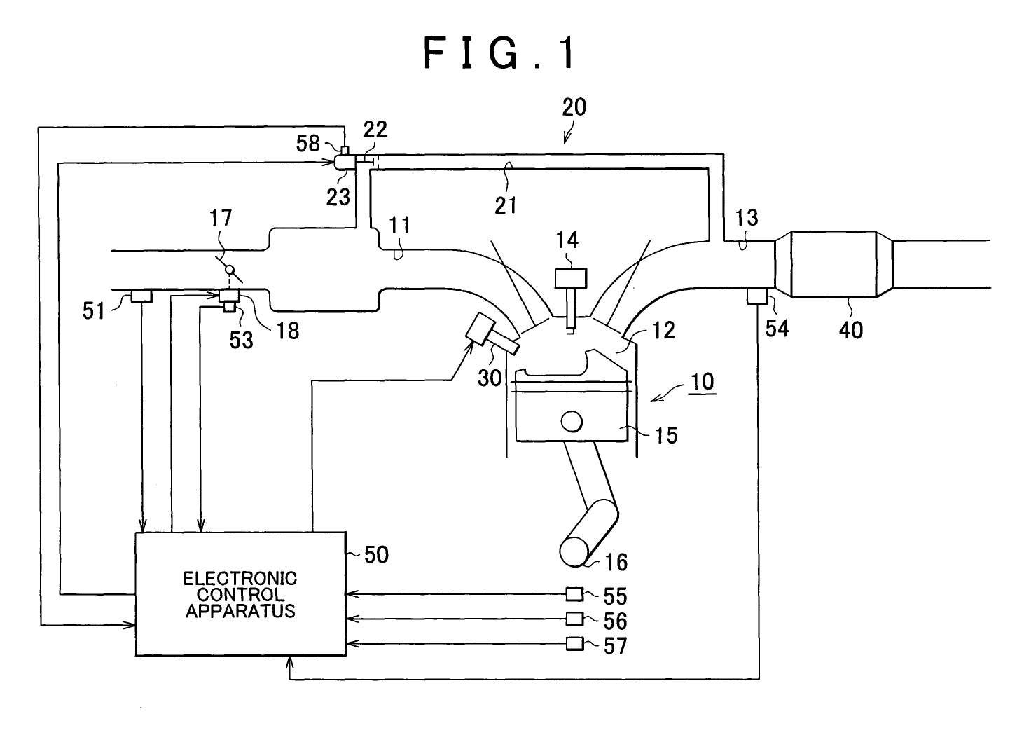

A first embodiment of an abnormality diagnosis apparatus for an exhaust gas recirculation apparatus according to the invention will be described specifically below with reference to FIGS. 1 to 3. FIG. 1 is a schematic constitutional diagram showing an internal combustion engine 10 to which the abnormality diagnosis apparatus for an exhaust gas recirculation apparatus according to this embodiment is applied and a peripheral constitution thereof.

As shown in FIG. 1, an intake passage 11 and an exhaust passage 13 are connected to a combustion chamber 12 of the internal combustion engine 10. The internal combustion engine 10 is also provided with a fuel injection valve 30 that injects fuel toward a piston 15 disposed within a cylinder. Hence, the fuel supplied by the fuel injection valve 30 and air supplied through the intake passage 11 mix together in the combustion chamber 12, whereupon the resultant air-fuel mixture is ignited by a spark plug 14 and burned. Exhaust gas resulting from the combustion is discharged to the exhaust passage 13.

A throttle valve 17 for adjusting the amount of intake air (intake air amount) flowing through the intake passage 11 and a throttle actuator 18 for adjusting the opening of the throttle valve 17 are provided in the intake passage 11. Further, a throttle valve opening sensor 53 that outputs a signal corresponding to the opening of the throttle valve 17 is attached to the throttle valve 17, and an air flow meter 51 that outputs a signal corresponding to the intake air amount is attached to the intake passage 11 on an upstream side of the throttle valve 17.

The exhaust passage 13 is provided with an exhaust gas purification catalyst 40 that causes a reaction to purify the exhaust gas flowing through the exhaust passage 13. Further, an oxygen concentration sensor 54 that outputs a continuous signal (a continuous value) in accordance with the oxygen concentration of the exhaust gas flowing through the exhaust passage 13 is provided in the exhaust passage 13 on the upstream side of the catalyst 40. More specifically, a conventional limiting current type oxygen sensor having an element that is sintered using zirconia, for example, as a material, an electrode formed from platinum and disposed on a part of inner and outer peripheral surfaces of the element, and a heater for maintaining the element at a constant temperature (none of which are shown in the drawings) may be used as the oxygen concentration sensor 54. The oxygen concentration sensor 54 has a characteristic whereby the magnitude of an output signal (limiting current value) thereof varies linearly in a lean air-fuel ratio region and a rich air-fuel ratio region in accordance with the leanness (corresponding to the oxygen concentration) or the richness. Note that when the element temperature of the oxygen concentration sensor 54 is no lower than a predetermined activation temperature, the oxygen concentration can be detected with a high degree of precision.

An EGR apparatus 20 is constituted by an exhaust gas recirculation passage (EGR passage) 21 that connects the intake passage 11 to the exhaust passage 13, and an exhaust gas amount control valve (EGR valve) 22 for adjusting the amount of exhaust gas that flows through the EGR passage 21. The EGR valve 22 is provided with an EGR actuator 23 for adjusting the opening of the valve 22, and an EGR valve opening sensor 58 that outputs a signal corresponding to the opening of the valve 22. When the EGR actuator 23 is driven to open the EGR valve 22, a part of the exhaust gas in the exhaust passage 13 is introduced into the intake passage 11 on a downstream side of the throttle valve 17.

In addition to the sensors described above, the internal combustion engine 10 is provided with various sensors for learning the operating conditions of the engine 10. More specifically, a crank position sensor 55 for detecting a rotation speed (engine rotation speed) of a crank shaft 16 which is rotated by a reciprocating motion of the piston 15, a vehicle speed sensor 56 for detecting a vehicle speed of a vehicle in which the engine 10 is installed, and an accelerator pedal depression amount sensor 57 for detecting a depression amount of an accelerator pedal, not shown in the drawing, are provided. These sensors respectively output signals corresponding to detection values.

The engine 10 is further provided with an electronic control apparatus 50 for performing overall control of the various apparatuses. The electronic control apparatus 50 is provided with a central processing unit (CPU) and a memory for storing and holding various control programs, calculation maps, data calculated during control execution, and so on. The signals output by the various sensors described above are input into the electronic control apparatus 50.

The electronic control apparatus 50 learns the operating conditions of the internal combustion engine 10 on the basis of the signals from the various sensors, and executes various types of control in accordance with the learned operating conditions. For example, the electronic control apparatus 50 executes ignition timing control to adjust the ignition timing of the spark plug 14, and throttle control for driving the throttle actuator 18 to adjust the opening of the throttle valve 17. Further, to control the manner in which fuel is injected by the fuel injection valve 30, the electronic control apparatus 50 executes air-fuel ratio control to adjust the fuel supply amount on the basis of the output value of the oxygen concentration sensor 54 such that the air-fuel ratio of the air-fuel mixture in the combustion chamber 12 converges with a target air-fuel ratio, and fuel cut processing to halt the fuel supply in order to improve a fuel consumption rate.

The fuel cut processing is executed in accordance with an execution condition whereby the engine rotation speed of the internal combustion engine 10 is no lower than an execution permission speed Ne and the vehicle is in a deceleration condition, and stopped in accordance with a stopping condition whereby the engine rotation speed is lower than the execution permission speed Ne or the vehicle is in an acceleration condition. The electronic control apparatus 50 learns the engine rotation speed on the basis of a signal from the crank position sensor 55, learns the condition of the vehicle on the basis of signals from the vehicle speed sensor 56, accelerator pedal depression amount sensor 57, and so on, and executes the fuel cut processing after determining that the execution condition of the processing has been established. On the other hand, the electronic control apparatus 50 stops the fuel cut processing after determining that the stopping condition has been established during execution of the processing.

Further, the electronic control apparatus 50 executes EGR control by driving the EGR actuator 23 to adjust the opening of the EGR valve 22, and determines whether or not an abnormality has occurred in the EGR valve 22 during execution of the fuel cut processing, or in other words executes an “EGR abnormality diagnosis routine” to execute an abnormality diagnosis on the EGR valve 22. Note that the “EGR abnormality diagnosis routine” executed by the electronic control apparatus 50 corresponds to the processing of an EGR abnormality diagnosis unit.

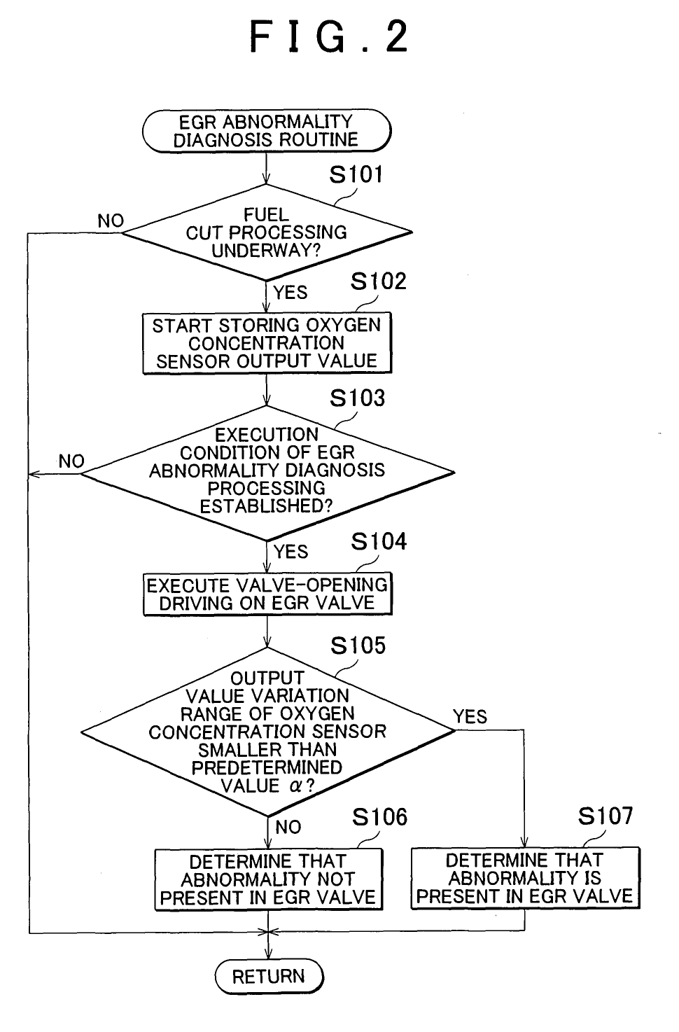

FIG. 2 is a flowchart showing a processing procedure of the “EGR abnormality diagnosis routine”. The series of processes shown in the drawing is executed repeatedly by the electronic control apparatus 50 at predetermined periods.

First, in the series of processes, a determination is made as to whether or not the fuel cut processing is underway (step S101). More specifically, a determination is made as to whether or not fuel is being supplied from the fuel injection valve 30. When it is determined that the fuel cut processing is not underway (step S101: NO), the series of processes is temporarily terminated.

On the other hand, when it is determined that the fuel cut processing is underway (step S101: YES), storage of the output value of the oxygen concentration sensor begins (step S102). Next, a determination is made as to whether or not an execution condition of EGR abnormality diagnosis processing is established (step S103). More specifically, the execution condition is established when activation of the oxygen concentration sensor 54 is complete and a predetermined time period Ta has elapsed following the start of execution of the fuel cut processing, and a determination is made as to whether or not this condition has been established. Note that completion of activation of the oxygen concentration sensor 54 is determined by determining whether or not a period of time required to secure the output value of the oxygen concentration sensor 54 following start-up of the engine 10 has elapsed, for example. This time period is set in advance through experiment or the like to be longer than a period required for the element temperature of the oxygen concentration sensor 54 to reach the activation temperature.

Further, the predetermined time period Ta from the start of execution of the fuel cut processing is set in advance in accordance with the operating conditions of the engine 10 at a period during which it is possible to determine that the respective interiors of the combustion chamber 12 and the intake passage 13 of the internal combustion engine 10 have been filled with air. The engine rotation speed may be cited as an example of the operating conditions of the internal combustion engine 10. Further, the determination as to whether or not the interiors of the combustion chamber 12 and intake passage 13 have been filled with air may be made in accordance with an integrated value of the intake air amount or the engine rotation speed instead of the elapsed time (the elapse of the predetermined time period Ta) from the start of execution of the fuel cut processing. These values are set in advance on the basis of a theoretical value or an experimental value, taking into consideration the respective volumes of the combustion chamber 12, the intake passage 11, and the exhaust passage 13, variation caused by the engine operating conditions, and so on.

When it is determined through this determination processing that the execution condition of the EGR abnormality diagnosis processing is not established (step S103: NO), the series of processes is temporarily terminated. On the other hand, when it is determined that the execution condition of the EGR abnormality diagnosis processing is established (step S103: YES), valve-opening driving is executed on the EGR valve (step S104). Specifically, the EGR actuator 23 is driven to open the EGR valve 22.

Next, a determination is made as to whether or not an output value variation range of the oxygen concentration sensor is smaller than a predetermined value a (step S105). More specifically, referring to the stored output value of the oxygen concentration sensor 54, a point in time at which the output value varies most greatly while the EGR valve 22 is open, or in other words a point in time at which deviation in the output value of the oxygen concentration sensor 54 reaches a maximum while the valve 22 is open, is learned, and the deviation at this time is learned as the output value variation range of the oxygen concentration sensor 54. The variation range is then compared to the predetermined value α to determine whether the output value variation range of the oxygen concentration sensor 54 is smaller than the predetermined value α. Note that the predetermined value α is an expected minimum value of the output value variation range of the oxygen concentration sensor 54 when the EGR valve 22 is driven normally, which is set in advance taking into consideration the opening timing of the valve 22 following the start of execution of the fuel cut processing.

When it is determined through this determination processing that the output value variation range of the oxygen concentration sensor is not smaller than the predetermined value α, or in other words that the output value variation range of the oxygen concentration sensor is equal to or greater than the predetermined value α (step S105: NO), it may be determined that the exhaust gas in the EGR passage 21 has flowed into the intake passage 11 in accompaniment with the opening of the EGR valve 22 and then flowed through the exhaust passage 13, leading to variation in the oxygen concentration of the exhaust gas. In other words, it may be determined that the EGR valve 22 has been opened appropriately. It is therefore determined that an abnormality has not occurred in the EGR valve (step S106), whereupon the series of processes is terminated.

On the other hand, when it is determined that the output value variation range of the oxygen concentration sensor is smaller than the predetermined value α (step S105: YES), it may be determined that although valve-opening driving has been executed on the EGR valve 22, the oxygen concentration of the exhaust gas in the exhaust passage 13 has not varied. It is therefore determined that an abnormality has occurred in the EGR valve (step S107), whereupon the series of processes is terminated.

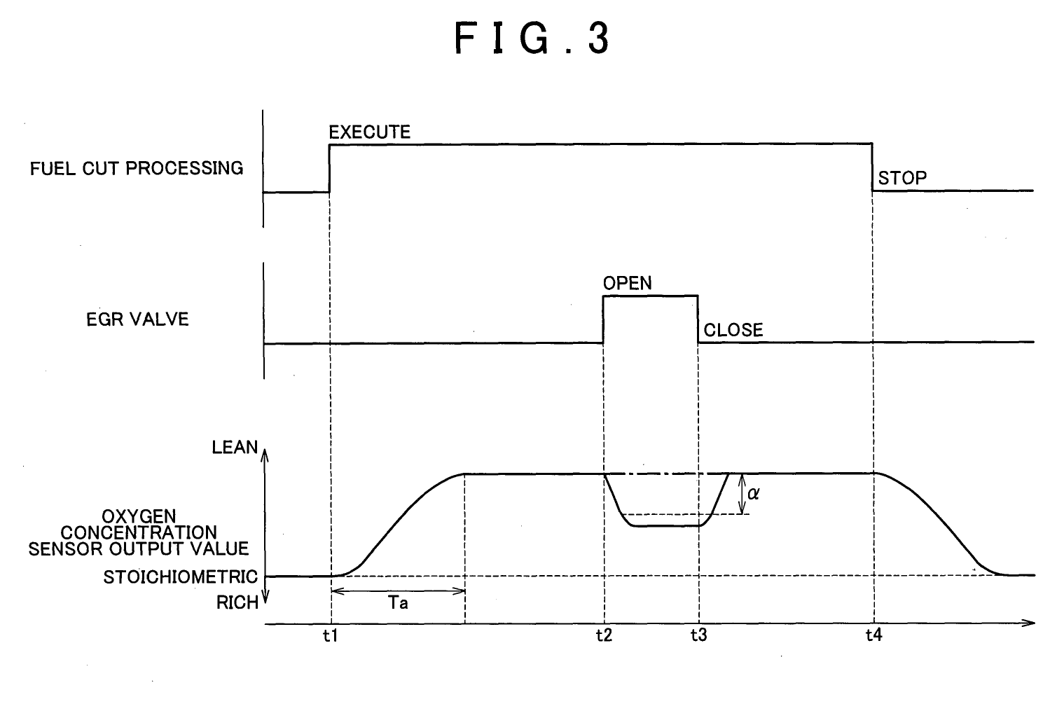

Next, referring to FIG. 3, an example of the course of the output value of the oxygen concentration sensor 54 during execution of the “EGR abnormality diagnosis routine” described above will be described. In the oxygen concentration sensor output value shown in FIG. 3, the course of the output value of the oxygen concentration sensor 54 in a case where the EGR valve 22 has been driven normally is indicated by a solid line, and the course of the output value of the oxygen concentration sensor 54 in a case where an abnormality has occurred in the EGR valve 22 is indicated by a dot-dash line. Note that at the start of the fuel cut processing (a timing t1), the EGR valve 22 is closed.

As shown in the drawings, when the fuel cut processing starts at the timing t1, the oxygen concentration in the exhaust passage 13 is raised by the air supplied through the intake passage 11, and therefore the output value of the oxygen concentration sensor 54 varies to a lean side. When the interiors of the combustion chamber 12 and the exhaust passage 13 are filled with air following the elapse of the predetermined time period Ta (step S103: YES), the output value of the sensor 54 stabilizes at a lean side value. At this time, the output value of the sensor 54 corresponds to the oxygen concentration of air.

When valve-opening driving is executed on the EGR valve 22 at a timing t2 (step S104), and an abnormality has not occurred in the valve 22, the exhaust gas that has accumulated in the EGR passage 21 flows into the combustion chamber 12 as the valve is opened, causing the oxygen concentration in the exhaust passage 13 to decrease temporarily such that the output value of the oxygen concentration sensor 54 varies to a rich side, as shown by the solid line in the drawing. As a result, the variation range of the oxygen concentration sensor 54 equals or exceeds the expected minimum value (predetermined value a) of the variation range (step S105: NO), and therefore in this case, it is determined that an abnormality has not occurred in the EGR valve 22 (step S106).

When an abnormality occurs in the EGR valve 22, on the other hand, the valve 22 is not driven normally, and therefore the flow rate through the EGR passage 21 no longer varies. An operation defect in the EGR valve 22 may be cited as an example of an abnormality in the valve 22. For example, when the EGR valve 22 becomes stuck in a closed state, the valve 22 does not open normally even when valve-opening driving is executed on the EGR valve 22, and therefore the exhaust gas that passes through the EGR passage 21 does not flow into the combustion chamber 12 and the exhaust passage 13. Meanwhile, when the EGR valve 22 becomes stuck in an open state, the interior of the EGR passage 21 becomes filled with air together with the combustion chamber 12 and the exhaust passage 13 from the start of the fuel cut processing (timing t1) to opening of the EGR valve 22 (timing t2), and therefore, when valve-opening driving is executed on the EGR valve 22, the air that passes through the EGR passage 21, rather than exhaust gas, flows into the combustion chamber 12 and exhaust passage 13 after the EGR valve 22 is opened. Hence, when an operation defect such as becoming stuck in an open state or a closed state occurs in the EGR valve 22, the amount by which the oxygen concentration of the exhaust gas in the exhaust passage 13 varies when the EGR valve 22 is driven to open falls below the expected variation amount. Accordingly, the variation range of the oxygen concentration sensor 54 falls below the expected minimum value (predetermined value a) of the variation range (step S105: YES), and therefore in this case, it is determined that an abnormality has occurred in the EGR valve 22 (step S107).

When the series of processes of the “EGR abnormality diagnosis routine” is terminated in the manner described above, the EGR valve 22 is closed at a timing t3, whereupon various other types of control are executed. When the EGR valve 22 is closed at the timing t3, the flow of exhaust gas through the EGR passage 21 is stopped, and therefore the output value of the oxygen concentration sensor 54 varies to the lean side and stabilizes at a lean side value.

Further, when the fuel cut processing is terminated at a timing t4, fuel is supplied from the fuel injection valve 30 and combustion resumes in the combustion chamber 12, and therefore the oxygen concentration of the exhaust gas in the exhaust passage 13 decreases. Air-fuel ratio feedback control is then executed, whereby the output value of the oxygen concentration sensor 54 varies so as to converge on the stoichiometric air-fuel ratio.

According to the first embodiment described above, the following actions and effects can be obtained. (1) The EGR valve 22 is driven to open during execution of the fuel cut processing, in which the fuel supply to the internal combustion engine 10 is stopped, and when the output value variation range of the oxygen concentration sensor 54 is smaller than the predetermined value α while the valve 22 is open, it may be determined that an abnormality has occurred in the EGR apparatus 20 (step S107). Hence, the presence of an abnormality in the EGR apparatus 20 can be determined accurately without providing a dedicated sensor for determining the presence of an abnormality in the apparatus 20. Furthermore, the presence of an abnormality in the apparatus 20 is determined during execution of the fuel cut processing, and therefore deterioration of the combustion condition in the combustion chamber 12 accompanying valve-opening driving of the EGR valve 22 can be suppressed.

(2) When the interiors of the combustion chamber 12 and the exhaust passage 13 are filled with the air that is supplied through the intake passage 11 during execution of the fuel cut processing, the output value of the oxygen concentration sensor 54 stabilizes at a lean side value. According to this embodiment, the EGR valve 22 is opened on condition that the interiors of the combustion chamber 12 and exhaust passage 13 of the internal combustion engine 10 have been filled with air upon the elapse of the predetermined time period Ta following the start of execution of the fuel cut processing, or in other words when the output value of the oxygen concentration sensor 54 is stable at a lean side value, and therefore a situation in which the output value of the oxygen concentration sensor 54 varies to the rich side when the EGR valve 22 is opened can be detected easily.

(3) In a case where an operation defect occurs in the EGR valve 22, the valve 22 is not driven normally even when valve-opening driving is executed on the valve 22, and therefore the flow rate in the EGR passage 21 no longer varies. Hence, according to this embodiment, it is possible to determine that an operation defect has occurred in the EGR valve 22 when the output value variation range of the oxygen concentration sensor 54 accompanying valve-opening driving of the EGR valve 22 is smaller than the predetermined value α.

Referring to FIG. 1 and FIGS. 4 to 6, a second embodiment of the abnormality diagnosis apparatus for an exhaust gas recirculation apparatus according to the invention will be described specifically, focusing on differences with the first embodiment. Note that detailed description of identical constitutions and processes to the first embodiment has been omitted.

This embodiment differs from the first embodiment on the following points. In the first embodiment, only processing for executing an abnormality diagnosis on the EGR valve 22, or in other words EGR abnormality diagnosis processing, is executed during the fuel cut processing. In this embodiment, on the other hand, processing for executing an abnormality diagnosis on the oxygen concentration sensor 54 (sensor abnormality diagnosis processing) is executed during the fuel cut processing in addition to the processing for executing an abnormality diagnosis on the EGR valve 22 (EGR abnormality diagnosis processing). Furthermore, an “abnormality diagnosis selection routine” for selecting one of the abnormality diagnosis processes is also executed.

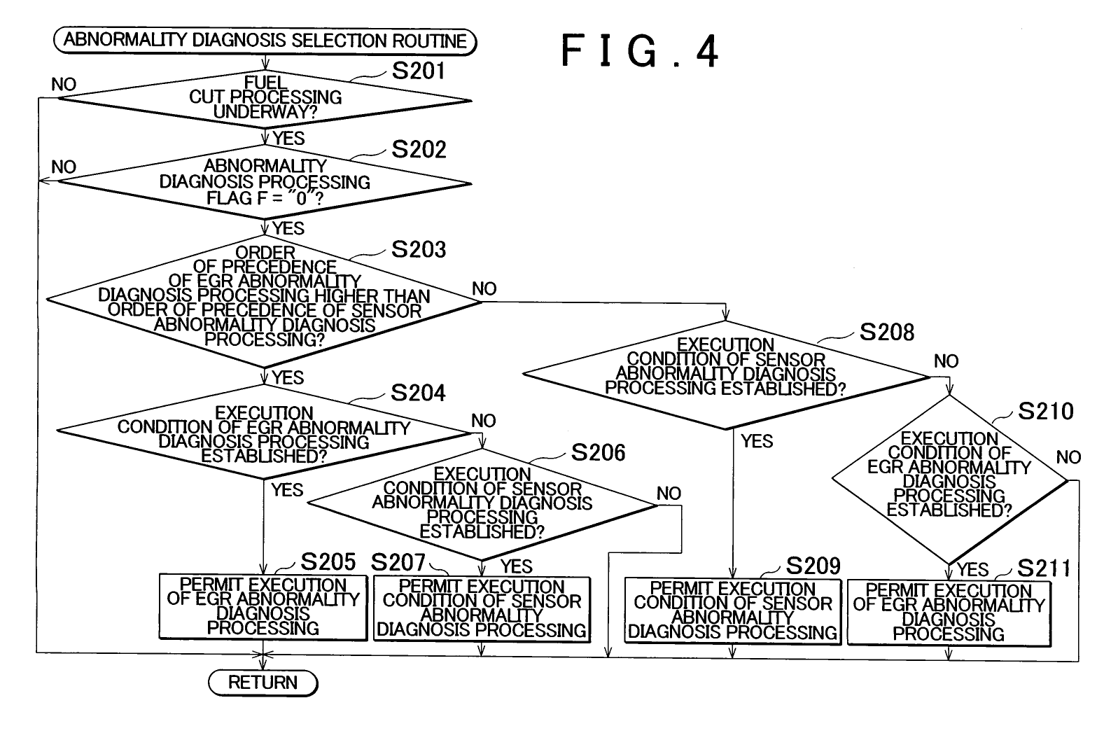

FIG. 4 is a flowchart showing a processing procedure of the “abnormality diagnosis selection routine”. This series of processes is executed repeatedly by the electronic control apparatus 50 at predetermined periods. Note that the “abnormality diagnosis selection routine” corresponds to the processing of an abnormality diagnosis selection unit.

In the series of processes shown in the drawing, first, a determination is made as to whether or not the fuel cut processing is underway (step S201). When it is determined that the fuel cut processing is not underway (step S201: NO), the series of processes is temporarily terminated.

On the other hand, when it is determined that the fuel cut processing is underway (step S201: YES), a determination is made as to whether or not an abnormality diagnosis processing flag F is at “0” (step S202). An initial value of the abnormality diagnosis processing flag F is “0”, and during the EGR abnormality diagnosis processing or the sensor abnormality diagnosis processing, the flag F is set at “1”.

When it is determined that the abnormality diagnosis processing flag F is not at “0”, i.e. that the flag F is at “1” (step S202: NO), the series of processes is temporarily terminated. Accordingly, the abnormality diagnosis processing that is currently underway continues to be executed.

On the other hand, when it is determined that the abnormality diagnosis processing flag F is at “0” (step S202: YES), it may be determined that neither the EGR abnormality diagnosis processing nor the sensor abnormality diagnosis processing is underway. Therefore, processing for determining the abnormality diagnosis processing to be executed first is executed in the following manner.

First, a determination is made as to whether or not an order of precedence of the EGR abnormality diagnosis processing is higher than an order of precedence of the sensor abnormality diagnosis processing (step S203). The order of precedence is determined in accordance with the operating conditions of the internal combustion engine 10, the execution frequency of the respective abnormality diagnosis processes, and so on. When it is determined that the order of precedence of the EGR abnormality diagnosis processing is higher than the order of precedence of the sensor abnormality diagnosis processing (step S203: YES), a determination is made as to whether or not the execution condition of the EGR abnormality diagnosis processing is established (step S204). More specifically, the execution condition is established when activation of the oxygen concentration sensor 54 is complete, an abnormality has not been detected in the oxygen concentration sensor 54, and the predetermined time period Ta has elapsed following the start of execution of the fuel cut processing, and a determination is made as to whether or not this condition has been established. Note that the presence of an abnormality in the oxygen concentration sensor 54 is detected in the sensor abnormality diagnosis processing, which is executed separately. In other words, when it is determined that an abnormality has occurred in the oxygen concentration sensor 54 during sensor abnormality diagnosis processing executed when the sensor abnormality diagnosis processing is permitted in the previously executed “abnormality diagnosis selection routine”, it is determined in the step S204 that the execution condition of the EGR abnormality diagnosis processing is not established.

When it is determined through this determination processing that the execution condition of the EGR abnormality diagnosis processing is established (step S204: YES), execution of the EGR abnormality diagnosis processing is permitted (step S205), whereupon the series of processes is terminated.

On the other hand, when it is determined that the execution condition of the EGR abnormality diagnosis processing is not established (step S204: NO), a determination is made as to whether or not an execution condition of sensor abnormality diagnosis processing is established (step S206). More specifically, the execution condition is established when activation of the oxygen concentration sensor 54 is complete, and a determination is made as to whether or not this condition has been established. When it is determined that the execution condition of the sensor abnormality diagnosis processing is established (step S206: YES), execution of the sensor abnormality diagnosis processing is permitted (step S207), whereupon the series of processes is terminated. On the other hand, when it is determined that the execution condition of the sensor abnormality diagnosis processing is not established (step S206: NO), the series of processes is terminated immediately.

When it is determined through the determination processing of the step S203 that the order of precedence of the EGR abnormality diagnosis processing is not higher than the order of precedence of the sensor abnormality diagnosis processing (step S203: NO), it may be determined that the sensor abnormality diagnosis processing has a higher order of precedence. Therefore, a determination is then made as to whether or not the execution condition of the sensor abnormality diagnosis processing is established (step S208). More specifically, the execution condition is established when activation of the oxygen concentration sensor 54 is complete, and similarly to the determination processing of the step S206, a determination is made as to whether or not this condition has been established. When it is determined that the execution condition of the sensor abnormality diagnosis processing is established (step S208: YES), execution of the sensor abnormality diagnosis processing is permitted (step S209), whereupon the series of processes is terminated.

On the other hand, when it is determined that the execution condition of the sensor abnormality diagnosis processing is not established (step S208: NO), a determination is made as to whether or not the execution condition of the EGR abnormality diagnosis processing is established (step S210). More specifically, the execution condition is established when activation of the oxygen concentration sensor 54 is complete, an abnormality has not been detected in the oxygen concentration sensor 54, and the predetermined time period Ta has elapsed following the start of execution of the fuel cut processing, and similarly to the determination processing of the step S204, a determination is made as to whether or not this condition has been established. When it is determined that the execution condition of the EGR abnormality diagnosis processing is established (step S210: YES), execution of the EGR abnormality diagnosis processing is permitted (step S211), whereupon the series of processes is terminated. On the other hand, when it is determined that the execution condition of the EGR abnormality diagnosis processing execution is not established (step S210: NO), the series of processes is terminated immediately.

Note that when negative determinations are made in the steps S206 and S210 such that the series of processes is terminated, it is determined that the execution conditions relating to both of the abnormality diagnosis processes are not established. In this case, the “abnormality diagnosis selection routine” is executed again, and when the execution condition of one of the abnormality diagnosis processes is established, execution of the abnormality diagnosis process for which the execution condition has been established is permitted.

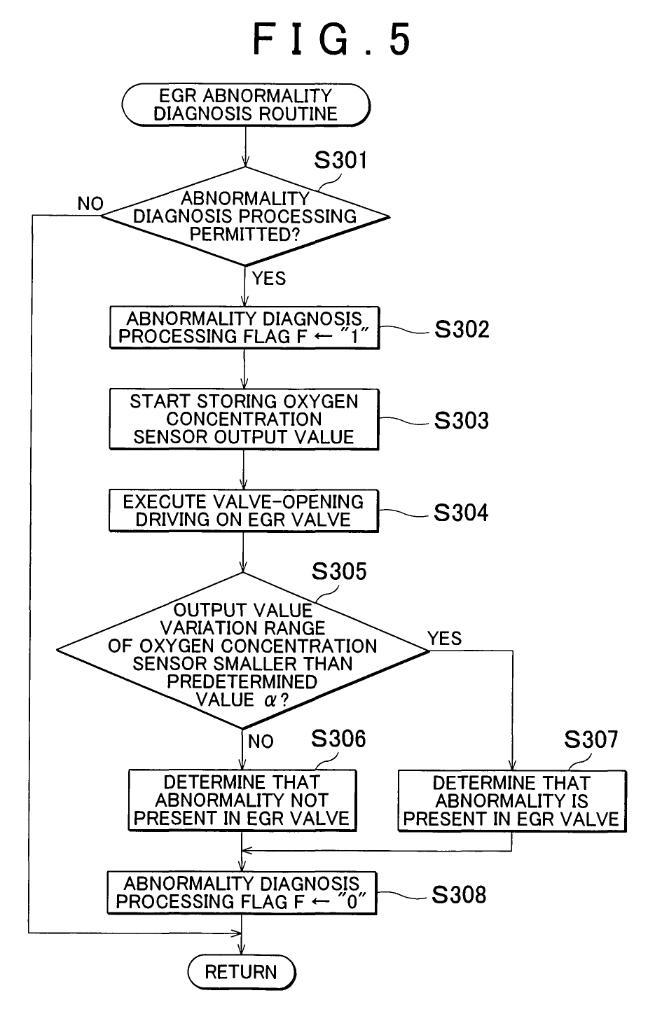

Next, referring to FIG. 5, a processing procedure of the “EGR abnormality diagnosis routine” will be described. The series of processes shown in the flowchart of the drawing is executed repeatedly by the electronic control apparatus 50 at predetermined periods. The “EGR abnormality diagnosis routine” is executed parallel to the “abnormality diagnosis selection routine” described above.

In this series of processes, first, a determination is made as to whether or not abnormality diagnosis processing is permitted (step S301). More specifically, it is determined that the abnormality diagnosis processing is permitted when execution is permitted in the step S205 or the step S211 of the “abnormality diagnosis selection routine” described above. When it is determined that execution of the abnormality diagnosis processing is not permitted (step S301: NO), the series of processes is temporarily terminated.

On the other hand, when it is determined that execution of the abnormality diagnosis processing is permitted (step S301: YES), the abnormality diagnosis processing flag F is set at “1” (step S302), whereupon the EGR abnormality diagnosis processing is begun.

In this processing, first, storage of the output value of the oxygen concentration sensor is begun (step S303), and then valve-opening driving is executed on the EGR valve (step S304). A determination is then made as to whether or not the output value variation range of the oxygen concentration sensor is smaller than the predetermined value α (step S305). More specifically, similarly to the determination processing of the step S105 described above, the point in time at which the output value varies most greatly while the EGR valve 22 is open, or in other words the point in time at which the deviation in the output value of the oxygen concentration sensor 54 reaches a maximum while the valve 22 is open, is learned by referring to the stored output value of the oxygen concentration sensor 54, and the deviation at this time is learned as the output value variation range of the oxygen concentration sensor. The variation range is then compared to the predetermined value α to determine whether the output value variation range of the oxygen concentration sensor 54 is smaller than the predetermined value α.

When it is determined through this determination processing that the output value variation range of the oxygen concentration sensor is not smaller than the predetermined value α, or in other words that the output value variation range of the oxygen concentration sensor is equal to or greater than the predetermined value α (step S305: NO), it is determined that an abnormality has not occurred in the EGR valve (step S306).

On the other hand, when it is determined that the output value variation range of the oxygen concentration sensor is smaller than the predetermined value α (step S305: YES), it is determined that an abnormality has occurred in the EGR valve (step S307).

When the EGR abnormality diagnosis processing is terminated after determining the presence or absence of an abnormality in the EGR valve 22 in the step S306 or the step S307, the abnormality diagnosis processing flag F is set at “0” (step S308), whereupon the series of processes is terminated. Note that the processing performed from the step S302 to the step S308 corresponds to the processing of the EGR abnormality diagnosis unit.

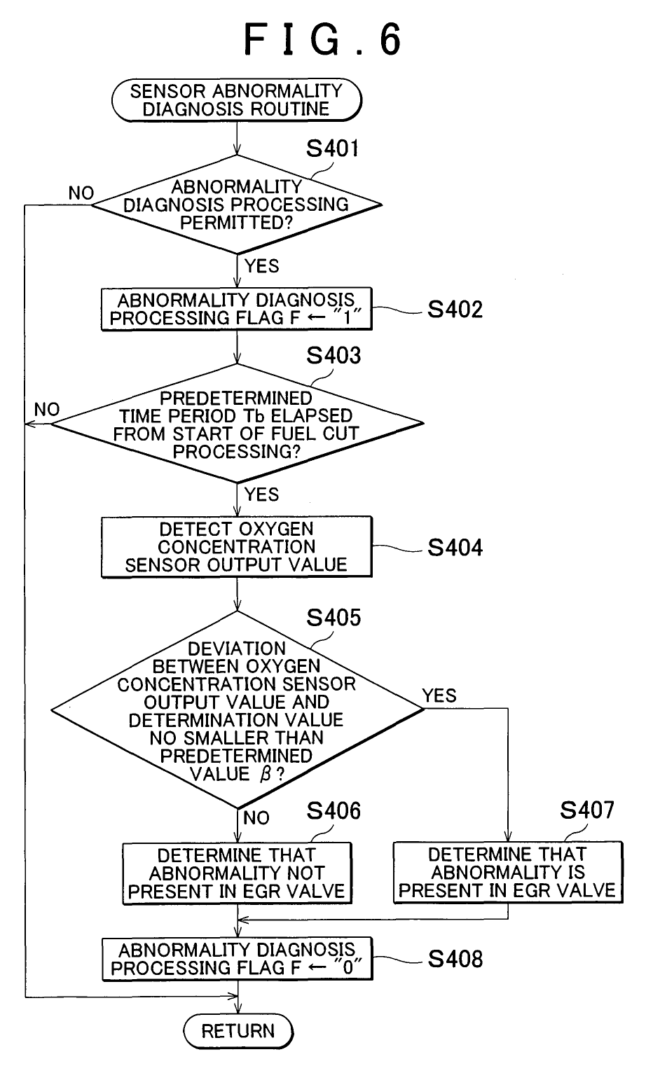

Next, referring to FIG. 6, a processing procedure of the “sensor abnormality diagnosis routine” will be described. The series of processes shown in the flowchart of the drawing is executed repeatedly by the electronic control apparatus 50 at predetermined periods. The “abnormality diagnosis selection routine” and the “EGR abnormality diagnosis routine” described above are respectively executed parallel to the “sensor abnormality diagnosis routine”.

In this series of processes, first, a determination is made as to whether or not abnormality diagnosis processing is permitted (step S401). More specifically, it is determined that the abnormality diagnosis processing is permitted when execution is permitted in the step S207 or the step S209 of the “abnormality diagnosis selection routine” described above. When it is determined that execution of the abnormality diagnosis processing is not permitted (step S401: NO), the series of processes is temporarily terminated.

On the other hand, when it is determined that execution of the abnormality diagnosis processing is permitted (step S401: YES), the abnormality diagnosis processing flag F is set at “1” (step S402), whereupon the sensor abnormality diagnosis processing is begun.

In this processing, first, a determination is made as to whether or not a predetermined time period Tb has elapsed following the start of the fuel cut processing (step S403). The predetermined time period Tb is set in advance on the basis of an experiment or the like at a time period extending from the start of the fuel cut processing in which the oxygen concentration of the exhaust gas flowing through the exhaust passage 13 can be assumed unambiguously. Note that the reason why it is possible to assume the oxygen concentration of the exhaust gas flowing through the exhaust passage 13 unambiguously in this manner is that during execution of the fuel cut processing, the air that flows into the combustion chamber 12 is discharged to the exhaust passage 13 as is. In other words, when the fuel cut processing is not underway and air-fuel ratio feedback control is executed on the basis of the output value of the oxygen concentration sensor 54, the exhaust gas that is generated in the combustion chamber 12 following combustion of the air-fuel mixture flows through the exhaust passage 13, and it is therefore difficult to assume the oxygen concentration of the exhaust gas unambiguously. However, when the fuel cut processing begins such that the path including the combustion chamber 12 is filled with air, it may be assumed unambiguously that the oxygen concentration of the exhaust gas flowing through the exhaust passage 13 corresponds to the oxygen concentration of air. When it is determined that the predetermined time period Tb has not elapsed following the start of the fuel cut processing (step S403: NO), it is difficult to assume the oxygen concentration of the exhaust gas in the exhaust passage 13 unambiguously, and therefore the output value of the oxygen concentration sensor 54 cannot be determined appropriately. Hence, the series of processes is temporarily terminated. Note that in this case, an affirmative determination is made in the step S401 of the routine during the next execution thereof (step S401: YES), and therefore the determination processing of the step S403 is executed repeatedly at fixed intervals until a determination result according to which the predetermined time period Tb has elapsed following the start of the fuel cut processing (step S403: YES) is obtained.

When it is determined through this determination processing that the predetermined time period Tb has elapsed following the start of the fuel cut processing (step S403: YES), the output value of the oxygen concentration sensor at this time is learned (step S404).

Next, a determination is made as to whether or not a deviation between the learned output value of the oxygen concentration sensor and a determination value equals or exceeds a predetermined value β (step S405). An expected output value of the oxygen concentration sensor 54 following the elapse of the predetermined time period Tb is set in advance as the determination value. Further, the predetermined value β is set in advance on the basis of an experiment or the like at a minimum value of the deviation between the output value of the oxygen concentration sensor 54 and the determination value at which it can be determined that an abnormality has occurred in the oxygen concentration sensor 54. When it is determined that the deviation between the output value of the oxygen concentration sensor and the determination value does not equal or exceed the predetermined value β (step S405: NO), it is determined that an abnormality has not occurred in the oxygen concentration sensor (step S406). On the other hand, when it is determined that the deviation between the output value of the oxygen concentration sensor and the determination value equals or exceeds the predetermined value β (step S405: YES), it is determined that an abnormality has occurred in the oxygen concentration sensor (step S407).

When the sensor abnormality diagnosis processing is terminated after determining the presence or absence of an abnormality in the oxygen concentration sensor 54 in the step S406 or the step S407, the abnormality diagnosis processing flag F is set at “0” (step S408), whereupon the series of processes is terminated. Note that the processing performed from the step S402 to the step S408 corresponds to the processing of a sensor abnormality diagnosis unit.

According to the second embodiment described above, the actions and effects described below in (4) and (5) can be obtained in addition to actions and effects pursuant to the actions and effects described above in (1) to (3). (4) When an abnormality diagnosis (EGR abnormality diagnosis processing) is executed on the EGR valve 22 during execution of an abnormality diagnosis (sensor abnormality diagnosis processing) on the oxygen concentration sensor 54, the output value of the oxygen concentration sensor 54 varies in accordance with valve-opening driving of the EGR valve 22 accompanying the EGR abnormality diagnosis processing, and therefore the precision of the abnormality diagnosis on the sensor 54 may decrease. Hence, in this embodiment, the “abnormality diagnosis selection routine” is executed to select one of the EGR abnormality diagnosis processing and the sensor abnormality diagnosis processing, and therefore a situation in which the abnormality diagnosis processes are executed simultaneously can be avoided, whereby a reduction in the precision of the abnormality diagnosis on the oxygen concentration sensor 54 can be suppressed. Note that the oxygen concentration sensor 54 is used in other types of control, such as air-fuel ratio control, as well as the EGR abnormality diagnosis processing, and therefore the sensor abnormality diagnosis processing is executed not only to ensure precision in the EGR abnormality diagnosis processing but also to ensure precision in the other types of control including the air-fuel ratio control. Hence, in this embodiment, even when the sensor abnormality diagnosis processing is executed, the processing load of the electronic control apparatus 50 that executes the processes does not increase, and a reduction in the precision of the abnormality diagnosis (EGR abnormality diagnosis processing) performed on the EGR apparatus 20 caused by an abnormality in the oxygen concentration sensor 54 can be suppressed.

(5) The order of precedence of the EGR abnormality diagnosis processing is compared to the order of precedence of the sensor abnormality diagnosis processing (step S203), and processing to determine whether or not the execution condition of the abnormality diagnosis processing having the higher order of precedence has been established is performed first (step S204, step S208). By setting an order of precedence in relation to the EGR abnormality diagnosis processing and the sensor abnormality diagnosis processing, determining establishment of the execution condition of the abnormality diagnosis processing in accordance with the order of precedence, and permitting execution of the abnormality diagnosis process for which the execution condition has been established, a situation in which the abnormality diagnosis processes are executed simultaneously can be prevented.

Referring to FIG. 1 and FIGS. 5 to 8, a third embodiment of the abnormality diagnosis apparatus for an exhaust gas recirculation apparatus according to the invention will be described specifically, focusing on differences with the second embodiment. Note that detailed description of similar constitutions and processes to those of the first and second embodiments has been omitted.

This embodiment differs from the second embodiment on the following points. In the “abnormality diagnosis selection routine” of the second embodiment, the series of processes is temporarily terminated when the abnormality diagnosis processing flag F is set at “1” (step S202: NO) and execution of the abnormality diagnosis processing that is currently underway is continued. In an “abnormality diagnosis selection routine” of this embodiment, on the other hand, the order of precedence of the abnormality diagnosis processing that is underway is confirmed when the abnormality diagnosis processing flag F is set at “1”, and if it is determined that the abnormality diagnosis processing having the lower order of precedence is already underway when the execution condition of the abnormality diagnosis processing having the higher order of precedence is established, the abnormality diagnosis processing is stopped.

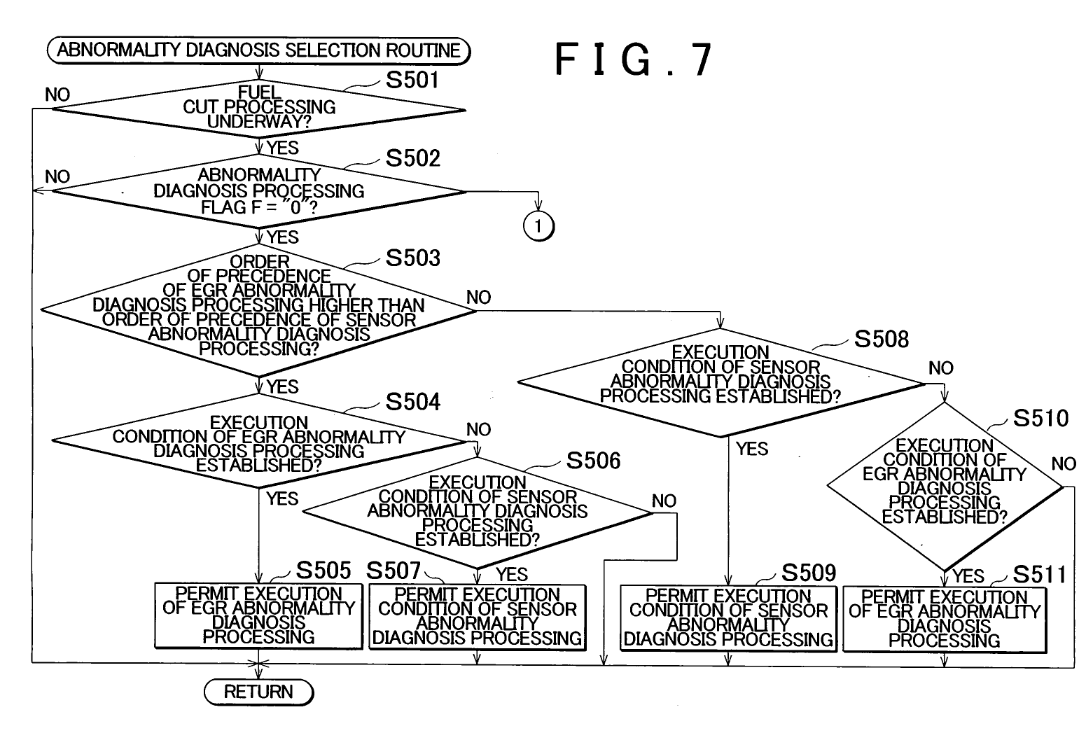

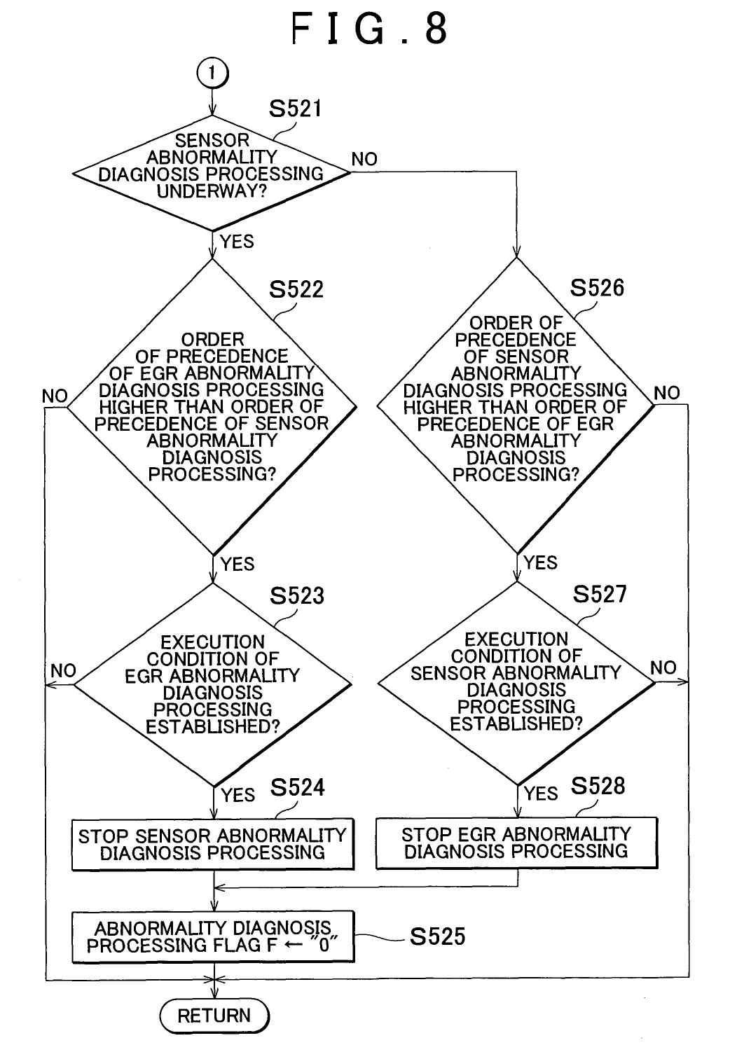

Referring to FIGS. 7 and 8, a processing procedure of the “abnormality diagnosis selection routine” will be described. The series of processes shown in this flowchart are executed repeatedly by the electronic control apparatus 50 at predetermined periods. Note that the “EGR abnormality diagnosis routine” shown in FIG. 5 and the “sensor abnormality diagnosis routine” shown in FIG. 6 are respectively executed parallel to the “abnormality diagnosis selection routine”.

In this series of processes, first, a determination is made as to whether or not the fuel cut processing is underway (step S501). When it is determined that the fuel cut processing is not underway (step S501: NO), the series of processes is temporarily terminated.

On the other hand, when it is determined that the fuel cut processing is underway (step S501: YES), a determination is made as to whether or not the abnormality diagnosis processing flag F is at “0” (step S502). The initial value of the abnormality diagnosis processing flag F is “0”, and the flag F is set at “1” when the EGR abnormality diagnosis processing or the sensor abnormality diagnosis processing is underway.

When it is determined that the abnormality diagnosis processing flag F is at “0” (step S502: YES), it may be determined that neither the EGR abnormality diagnosis processing nor the sensor abnormality diagnosis processing is underway, and therefore similar processing to that of the step S203 to the step S211 for determining the abnormality diagnosis processing to be executed first is executed from a step S503 to a step S511.

More specifically, a determination is made as to whether or not the order of precedence of the EGR abnormality diagnosis processing is higher than the order of precedence of the sensor abnormality diagnosis processing (step S503). When it is determined that the order of precedence of the EGR abnormality diagnosis processing is higher than the order of precedence of the sensor abnormality diagnosis processing (step S503: YES), a determination is made as to whether or not the execution condition of the EGR abnormality diagnosis processing is established (step S504). When it is determined that the execution condition of the EGR abnormality diagnosis processing is established (step S504: YES), execution of the EGR abnormality diagnosis processing is permitted (step S505), whereupon the series of processes is terminated.

On the other hand, when it is determined that the execution condition of the EGR abnormality diagnosis processing is not established (step S504: NO), a determination is made as to whether or not the execution condition of the sensor abnormality diagnosis processing is established (step S506). When it is determined that the execution condition of the sensor abnormality diagnosis processing is established (step S506: YES), execution of the sensor abnormality diagnosis processing is permitted (step S507), whereupon the series of processes is terminated. On the other hand, when it is determined that the execution condition of the sensor abnormality diagnosis processing is not established (step S506: NO), the series of processes is terminated immediately.

When it is determined through the determination processing of the step S503 that the order of precedence of the EGR abnormality diagnosis processing is not higher than the order of precedence of the sensor abnormality diagnosis processing (step S503: NO), it may be determined that the sensor abnormality diagnosis processing has a higher order of precedence. Therefore, a determination is then made as to whether or not the execution condition of the sensor abnormality diagnosis processing is established (step S508). When it is determined that the execution condition of the sensor abnormality diagnosis processing is established (step S508: YES), execution of the sensor abnormality diagnosis processing is permitted (step S509), whereupon the series of processes is terminated.

On the other hand, when it is determined that the execution condition of the sensor abnormality diagnosis processing is not established (step S508: NO), a determination is made as to whether or not the execution condition of the EGR abnormality diagnosis processing is established (step S510). When it is determined that the execution condition of the EGR abnormality diagnosis processing is established (step S510: YES), execution of the EGR abnormality diagnosis processing is permitted (step S511), whereupon the series of processes is terminated. On the other hand, when it is determined that the execution condition of the EGR abnormality diagnosis processing is not established (step S510: NO), the series of processes is terminated immediately. Note that when negative determinations are made in the steps S506 and S510 such that the series of processes is terminated, and the execution condition of one of the abnormality diagnosis processes is established during the next execution of the “abnormality diagnosis selection routine”, execution of the abnormality diagnosis process for which the execution condition has been established is permitted.

When it is determined through the determination processing of the step S502 that the abnormality diagnosis processing flag F is set at “1” (step S502: NO), it may be determined that one of the EGR abnormality diagnosis processing and the sensor abnormality diagnosis processing is underway. Therefore, processing for determining whether to continue or stop the abnormality diagnosis processing that is underway is executed in the following manner.

First, to specify the abnormality diagnosis processing that is underway, a determination is made as to whether or not the sensor abnormality diagnosis processing is underway (step S521), as shown in FIG. 8. Note that in this step, the abnormality diagnosis processing that is underway may be specified by determining whether the EGR abnormality diagnosis processing is underway.

When it is determined through this determination processing that the sensor abnormality diagnosis processing is underway (step S521: YES), a determination is made as to whether or not the order of precedence of the EGR abnormality diagnosis processing is higher than the order of precedence of the sensor abnormality diagnosis processing (step S522). More specifically, a determination is made as to whether or not the order of precedence of the EGR abnormality diagnosis processing which is not underway is higher than the order of precedence of the sensor abnormality diagnosis processing which is underway. When it is determined that the order of precedence of the EGR abnormality diagnosis processing is not higher than the order of precedence of the sensor abnormality diagnosis processing, or in other words that the sensor abnormality diagnosis processing that is underway has a higher order of precedence (step S522: NO), the series of processes is terminated and the sensor abnormality diagnosis processing that is underway continues to be executed.

On the other hand, when it is determined that the order of precedence of the EGR abnormality diagnosis processing is higher than the order of precedence of the sensor abnormality diagnosis processing (step S522: YES), a determination is made as to whether or not the execution condition of the EGR abnormality diagnosis processing is established (step S523). When it is determined that the execution condition of the EGR abnormality diagnosis processing is established (step S523: YES), the sensor abnormality diagnosis processing that is underway is stopped (step S524). In other words, the execution condition of the EGR abnormality diagnosis processing having the higher order of precedence is established during execution of the sensor abnormality diagnosis processing having the lower order of precedence, and therefore the sensor abnormality diagnosis processing that is underway is stopped. On the other hand, when it is determined that the execution condition of the EGR abnormality diagnosis processing is not established (step S523: NO), the series of processes is temporarily terminated and the sensor abnormality diagnosis processing that is underway continues to be executed.

When it is determined in the step S521 that the sensor abnormality diagnosis processing is not underway (step S521: NO), it may be determined that the EGR abnormality diagnosis processing is underway. Therefore, a determination is made as to whether or not the order of precedence of the sensor abnormality diagnosis processing that is not underway is higher than the order of precedence of the EGR abnormality diagnosis processing that is underway (step S526). When it is determined that the order of precedence of the Sensor abnormality diagnosis processing is not higher than the order of precedence of the EGR abnormality diagnosis processing, or in other words that the EGR abnormality diagnosis processing that is underway has a higher order of precedence (step S526: NO), the series of processes is terminated and the EGR abnormality diagnosis processing that is underway continues to be executed.

On the other hand, when it is determined that the order of precedence of the sensor abnormality diagnosis processing is higher than the order of precedence of the EGR abnormality diagnosis processing (step S526: YES), a determination is made as to whether or not the execution condition of the sensor abnormality diagnosis processing having the higher order of precedence is established (step S527). When it is determined that the execution condition of the sensor abnormality diagnosis processing is established (step S527: YES), the EGR abnormality diagnosis processing that is underway is stopped (step S528). In other words, the execution condition of the sensor abnormality diagnosis processing having the higher order of precedence is established during execution of the EGR abnormality diagnosis processing having the lower order of precedence, and therefore the EGR abnormality diagnosis processing that is underway is stopped. On the other hand, when it is determined that the execution condition of the sensor abnormality diagnosis processing is not established (step S527: NO), the series of processes is temporarily terminated and the EGR abnormality diagnosis processing that is underway continues to be executed.

When the abnormality diagnosis processing that is underway is stopped in the step S524 or the step S528, a state is generated in which neither of the abnormality diagnosis processes is executed. Accordingly, the abnormality diagnosis processing flag F is set at “0” (step S525) and the series of processes is terminated. In this case, it is determined that the execution condition of the abnormality diagnosis processing having the higher order of precedence has been established in the “abnormality diagnosis selection routine” executed next from the step S501, and therefore execution of the abnormality diagnosis processing having the higher order of precedence is permitted (step S505, step S509). Further, when the execution condition of the abnormality diagnosis processing having the higher order of precedence is established (step S523: YES, step S527: YES) during the next “abnormality diagnosis selection routine” after execution of the abnormality diagnosis processing having the lower order of precedence has been permitted (step S507, step S511), the abnormality diagnosis processing that is underway is stopped (step S524, step S528).

According to the third embodiment described above, the actions and effects described below in (6) can be obtained in addition to actions and effects pursuant to the actions and effects described above in (1) to (5). (6) When the execution condition of the abnormality diagnosis processing having the higher order of precedence is established while the other abnormality diagnosis processing is already underway, the abnormality diagnosis processing is stopped (step S524, step S528), and therefore the abnormality diagnosis processing having the higher order of precedence can be executed earlier.

Referring to FIGS. 1, 5, 6 and 9, a fourth embodiment of the abnormality diagnosis apparatus for an exhaust gas recirculation apparatus according to the invention will be described specifically, focusing on differences with the second and third embodiments. Note that detailed description of similar constitutions and processes to those of the respective embodiments described above has been omitted.

This embodiment differs from the embodiments described above on the following points. In the “abnormality diagnosis selection routine” of the second and third embodiments, an order of precedence is set in relation to the EGR abnormality diagnosis processing and the sensor abnormality diagnosis processing, establishment of the execution condition of the abnormality diagnosis processing is determined in accordance with the order of precedence, and execution of the abnormality diagnosis processing for which the execution condition has been established is permitted. In the “abnormality diagnosis selection routine” of this embodiment, on the other hand, execution of the sensor abnormality diagnosis processing is permitted on condition that the EGR abnormality diagnosis processing is not underway.

Further, in the determination processing of the step S301 in the “EGR abnormality diagnosis routine” of the second and third embodiments, shown in FIG. 5, a determination as to whether or not execution of the EGR abnormality diagnosis processing is permitted is made in the “abnormality diagnosis selection routine”, which is executed as a separate routine, and when it is determined that execution of the EGR abnormality diagnosis processing is permitted, the EGR abnormality diagnosis processing is executed from the step S302 onward. In the “EGR abnormality diagnosis routine” of this embodiment, on the other hand, a determination as to whether or not the execution condition of the EGR abnormality diagnosis processing has been established is made in the step S301, and when the execution condition has been established, the EGR abnormality diagnosis processing is executed from the step S302 onward. More specifically, the execution condition is established when activation of the oxygen concentration sensor 54 is complete, an abnormality has not been detected in the oxygen concentration sensor 54, and the predetermined time period Ta has elapsed following the start of execution of the fuel cut processing, and similarly to the determination processing of the step S204 described above, a determination is made as to whether or not this condition has been established.

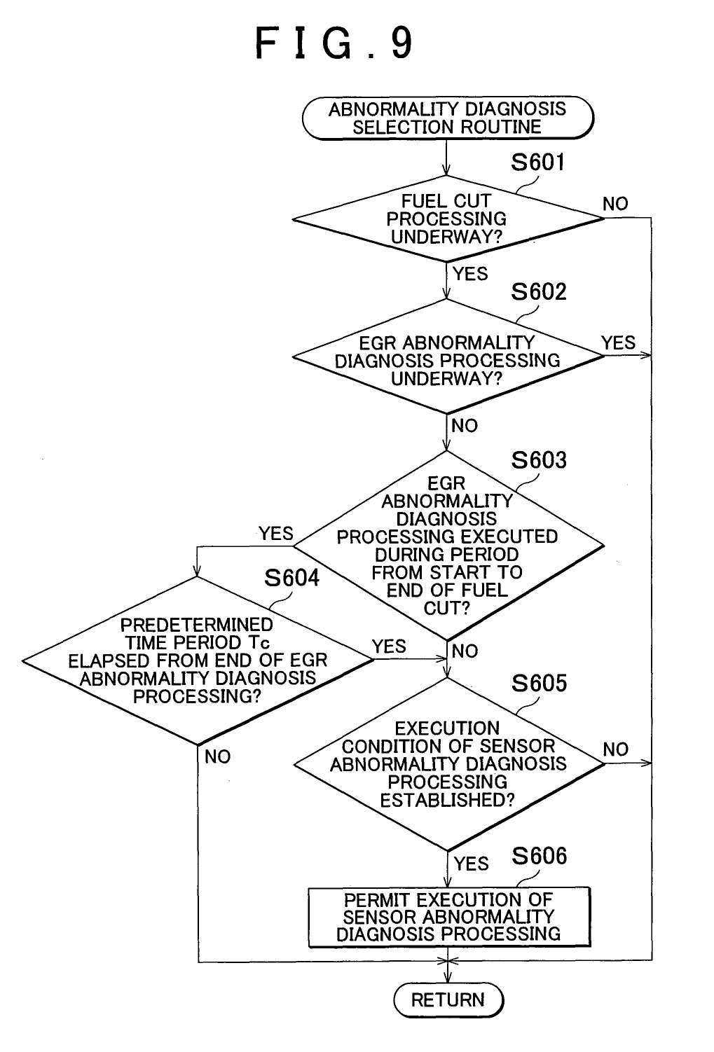

Referring to FIG. 9, a processing procedure of the “abnormality diagnosis selection routine” will be described. The series of processes shown in the flowchart of the drawing is executed repeatedly by the electronic control apparatus 50 at predetermined periods. The “EGR abnormality diagnosis routine” shown in FIG. 5 and the “sensor abnormality diagnosis routine” shown in FIG. 6 are respectively executed parallel to the “abnormality diagnosis selection routine”.

In this series of processes, first, a determination is made as to whether or not the fuel cut processing is underway (step S601). When it is determined that the fuel cut processing is not underway (step S601: NO), the series of processes is temporarily terminated. On the other hand, when it is determined that the fuel cut processing is underway (step S601: YES), a determination is made as to whether or not the EGR abnormality diagnosis processing is underway (step S602). As noted above, the EGR abnormality diagnosis processing is executed when the execution condition of the abnormality diagnosis processing is determined to be established in the step S301 of the “EGR abnormality diagnosis routine”, and therefore in this case, an affirmative determination is made in this step.

When it is determined through this determination processing that the EGR abnormality diagnosis processing is underway (step S602: YES), the series of processes is terminated and the EGR abnormality diagnosis processing that is underway continues to be executed.

On the other hand, when it is determined that the EGR abnormality diagnosis processing is not underway (step S602: NO), a determination is made as to whether or not the EGR abnormality diagnosis processing has been executed during a period extending from the start to the completion of the fuel cut processing (step S603).

When the EGR abnormality diagnosis processing is already underway during the fuel cut processing, the output value of the oxygen concentration sensor 54 varies while the EGR valve 22 is open during the EGR abnormality diagnosis processing, and therefore, if the sensor abnormality diagnosis processing is executed immediately after the EGR abnormality diagnosis processing, the precision of the abnormality diagnosis performed on the oxygen concentration sensor 54 may decrease.

Hence, when it is determined through the determination processing of the step S603 that the EGR abnormality diagnosis processing has been executed during the period extending from the start to the completion of the fuel cut processing (step S603: YES), a determination is made as to whether or not a predetermined time period Tc has elapsed following completion of the EGR abnormality diagnosis processing (step S604). The predetermined time period Tc is a period during which variation in the output value of the oxygen concentration sensor 54 occurring while the EGR valve 22 is open can decrease sufficiently, and is set in advance on the basis of a theoretical value or an experimental value, taking into consideration the volume and length of the EGR passage 21, the response speed of the EGR valve 22, the respective volumes of the combustion chamber 12 and the exhaust passage 13, the engine rotation speed, and so on.

When it is determined that the predetermined time period Tc has not elapsed following completion of the EGR abnormality diagnosis processing (step S604: NO), the precision of the abnormality diagnosis performed on the oxygen concentration sensor 54 may decrease, as described above, and therefore the series of processes is temporarily terminated.

On the other hand, when it is determined that the predetermined time period Tc has elapsed following completion of the EGR abnormality diagnosis processing (step S604: YES) or when it is determined through the determination processing of the step S603 that the EGR abnormality diagnosis processing has not been executed during the period extending from the start to the completion of the fuel cut processing (step S603: NO), a determination is made as to whether or not the execution condition of the sensor abnormality diagnosis processing is established (step S605). When it is determined that the execution condition of the sensor abnormality diagnosis processing is established (step S605: YES), execution of the sensor abnormality diagnosis processing is permitted (step S606), whereupon the series of processes is temporarily terminated. In this case, an affirmative determination is made in the step S401 of the “sensor abnormality diagnosis routine” shown in FIG. 6, and therefore the sensor abnormality diagnosis processing is executed from the step S402 onward. When it is determined that the execution condition of the sensor abnormality diagnosis processing is not established (step S605: NO), on the other hand, the series of processes is terminated immediately.

According to the fourth embodiment described above, the actions and effects described below in (7) can be obtained in addition to actions and effects pursuant to the actions and effects described above in (1) to (4). (7) When the EGR abnormality diagnosis processing is executed first during the period extending from the start to the completion of the fuel cut processing, execution of the sensor abnormality diagnosis processing is permitted after the predetermined time period Tc has elapsed following stoppage of the abnormality diagnosis. As a result, the effect of the EGR abnormality diagnosis processing on the output value of the oxygen concentration sensor 54 can be suppressed, whereby a reduction in the precision of the sensor abnormality diagnosis can be suppressed.

Referring to FIGS. 1, 5, 6 and 10, a fifth embodiment of the abnormality diagnosis apparatus for an exhaust gas recirculation apparatus according to the invention will be described specifically, focusing on differences with the second and third embodiments. Note that detailed description of similar constitutions and processes to those of the respective embodiments described above has been omitted.

This embodiment differs from the embodiments described above on the following points. In the “abnormality diagnosis selection routine” of the second and third embodiments, an order of precedence is set in relation to the EGR abnormality diagnosis processing and the sensor abnormality diagnosis processing, establishment of the execution condition of the abnormality diagnosis processing is determined in accordance with the order of precedence, and execution of the abnormality diagnosis processing for which the execution condition has been established is permitted. In the “abnormality diagnosis selection routine” of this embodiment, on the other hand, execution of the EGR abnormality diagnosis processing is permitted on condition that the sensor abnormality diagnosis processing is not underway.

Further, in the determination processing of the step S401 in the “sensor abnormality diagnosis routine” of the second and third embodiments, shown in FIG. 6, a determination as to whether or not execution of the sensor abnormality diagnosis processing is permitted is made in the “abnormality diagnosis selection routine”, which is executed as a separate routine, and when it is determined that execution of the sensor abnormality diagnosis processing is permitted, the sensor abnormality diagnosis processing is executed from the step S402 onward. In the “sensor abnormality diagnosis routine” of this embodiment, on the other hand, a determination as to whether or not the execution condition of the sensor abnormality diagnosis processing is established is made in the step S401; and when the execution condition is established, the sensor abnormality diagnosis processing is executed from the step S402 onward. More specifically, the execution condition is established when activation of the oxygen concentration sensor 54 is complete, and similarly to the determination processing of the step S206 described above, a determination is made as to whether or not this condition has been established.

Note that this embodiment differs from the fourth embodiment in that in the fourth embodiment, execution of the sensor abnormality diagnosis processing is permitted on condition that the EGR abnormality diagnosis processing is not underway, whereas in this embodiment, execution of the EGR abnormality diagnosis processing is permitted on condition that the sensor abnormality diagnosis processing is not underway.

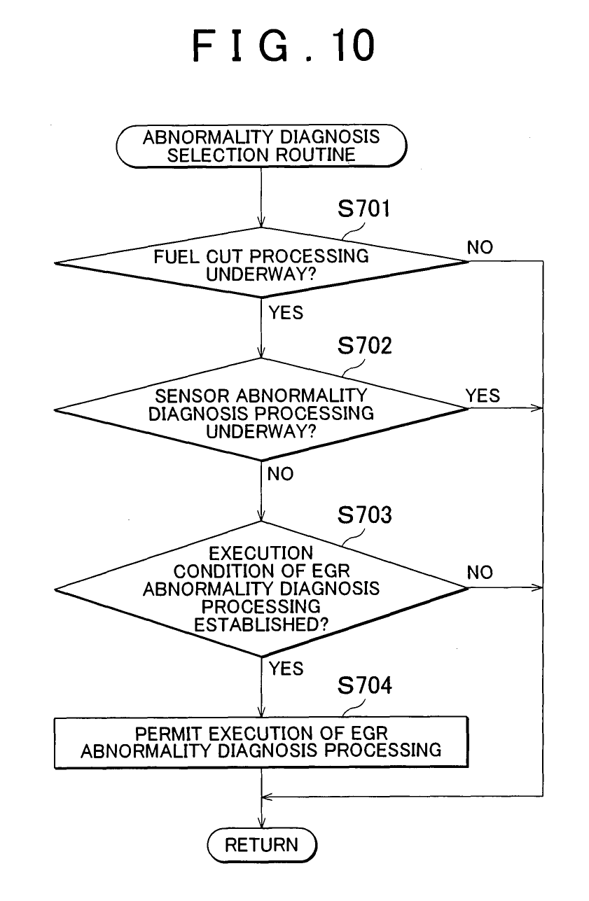

Referring to FIG. 10, a processing procedure of the “abnormality diagnosis selection routine” will be described. The series of processes shown in the flowchart of the drawing is executed repeatedly by the electronic control apparatus 50 at predetermined periods. The “EGR abnormality diagnosis routine” shown in FIG. 5 and the “sensor abnormality diagnosis routine” shown in FIG. 6 are respectively executed parallel to the “abnormality diagnosis selection routine”.

In this series of processes, first, a determination is made as to whether or not the fuel cut processing is underway (step S701). When it is determined that the fuel cut processing is not underway (step S701: NO), the series of processes is temporarily terminated. On the other hand, when it is determined that the fuel cut processing is underway (step S701: YES), a determination is made as to whether or not the sensor abnormality diagnosis processing is underway (step S702). As noted above, the sensor abnormality diagnosis processing is executed when the execution condition of the abnormality diagnosis processing is determined to be established in the step S401 of the “sensor abnormality diagnosis routine”, and therefore in this case, an affirmative determination is made in this step.

When it is determined through this determination processing that the sensor abnormality diagnosis processing is underway (step S702: YES), the series of processes is temporarily terminated and the sensor abnormality diagnosis processing that is underway continues to be executed.

On the other hand, when it is determined that the sensor abnormality diagnosis processing is not underway (step S702: NO), a determination is made as to whether or not the execution condition of the EGR abnormality diagnosis processing is established (step S703). More specifically, the execution condition is established when activation of the oxygen concentration sensor 54 is complete, an abnormality has not been detected in the oxygen concentration sensor 54, and the predetermined time period Ta has elapsed following the start of execution of the fuel cut processing, and similarly to the determination processing of the step S204 described above, a determination is made as to whether or not this condition has been established.

When it is determined that the execution condition of the EGR abnormality diagnosis processing is established (step S703: YES), execution of the EGR abnormality diagnosis processing is permitted (step S704), whereupon the series of processes is terminated. In this case, an affirmative determination is made in the step S301 of the “EGR abnormality diagnosis routine” shown in FIG. 5, and therefore the EGR abnormality diagnosis processing is executed from the step S302 onward. When it is determined that the execution condition of the EGR abnormality diagnosis processing is not established (step S703: NO), on the other hand, the series of processes is temporarily terminated.

According to the fifth embodiment described above, actions and effects pursuant to the actions and effects described above in (1) to (4) can be obtained. Referring to FIGS. 1, 5, 6 and 11, a sixth embodiment of the abnormality diagnosis apparatus for an exhaust gas recirculation apparatus according to the invention will be described specifically, focusing on differences with the second and third embodiments. Note that detailed description of similar constitutions and processes to those of the respective embodiments described above has been omitted.

This embodiment differs from the second and third embodiments on the following points. In the “abnormality diagnosis selection routine” of the third embodiment, the order of precedence of the EGR abnormality diagnosis processing is compared to the order of precedence of the sensor abnormality diagnosis processing, establishment of the execution condition of the abnormality diagnosis processing is determined in accordance with the order of precedence, and execution of the abnormality diagnosis processing for which the execution condition has been established is permitted. In other words, the order of precedence is set as desired in accordance with conditions.

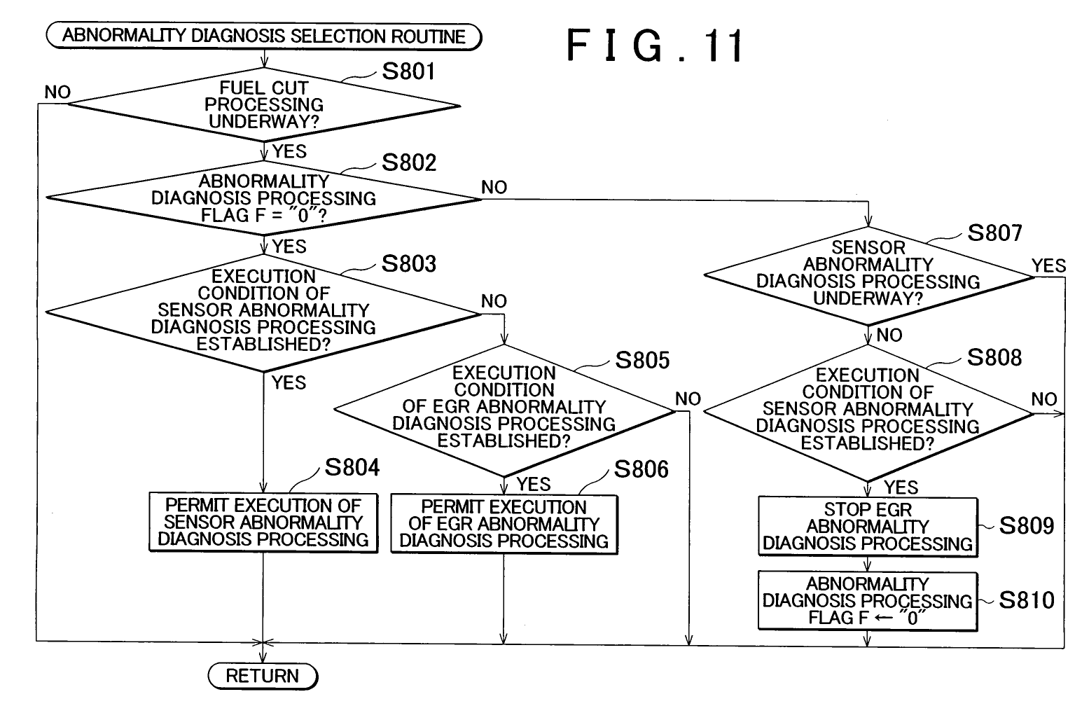

In the “abnormality diagnosis selection routine” of this embodiment, on the other hand, the order of precedence of the sensor abnormality diagnosis processing is set in advance to be higher than the order of precedence of the EGR abnormality diagnosis processing. FIG. 11 is a flowchart showing a processing procedure of the “abnormality diagnosis selection routine”. This series of processes is executed repeatedly by the electronic control apparatus 50 at predetermined periods. Note that the “EGR abnormality diagnosis routine” shown in FIG. 5 and the “sensor abnormality diagnosis routine” shown in FIG. 6 are respectively executed parallel to the “abnormality diagnosis selection routine”.

In this series of processes, first, a determination is made as to whether or not the fuel cut processing is underway (step S801). When it is determined that the fuel cut processing is not underway (step S801: NO), the series of processes is temporarily terminated.

On the other hand, when it is determined that the fuel cut processing is underway (step S801: YES), a determination is made as to whether or not the abnormality diagnosis processing flag F is at “0” (step S802). The initial value of the abnormality diagnosis processing flag F is “0”, and the flag F is set at “1” when the EGR abnormality diagnosis processing or the sensor abnormality diagnosis processing is underway.

When it is determined that the abnormality diagnosis processing flag F is at “0” (step S802: YES), it may be determined that neither the EGR abnormality diagnosis processing nor the sensor abnormality diagnosis processing is underway. Accordingly, processing for determining the abnormality diagnosis processing to be executed first is executed in the following manner.

First, a determination is made as to whether or not the execution condition of the sensor abnormality diagnosis processing is established (step S803). In other words, a determination as to whether or not the execution condition of the sensor abnormality diagnosis processing having the higher order of precedence has been established is made first. When it is determined that the execution condition of the sensor abnormality diagnosis processing is established (step S803: YES), execution of the sensor abnormality diagnosis processing is permitted (step S804), whereupon the series of processes is terminated.

On the other hand, when it is determined that the execution condition of the sensor abnormality diagnosis processing is not established (step S803: NO), a determination is made as to whether or not the execution condition of the EGR abnormality diagnosis processing is established (step S805). When it is determined that the execution condition of the EGR abnormality diagnosis processing is established (step S805: YES), execution of the EGR abnormality diagnosis processing is permitted (step S806), whereupon the series of processes is terminated. When it is determined that the execution condition of the EGR abnormality diagnosis processing is not established (step S805: NO), on the other hand, the series of processes is temporarily terminated. Note that in this case, when the execution condition of one of the abnormality diagnosis processes is established in the next “abnormality diagnosis selection routine”, execution of the abnormality diagnosis processing for which the execution condition has been established is permitted.

When it is determined through the determination processing of the step S802 that the abnormality diagnosis processing flag F is not at “0”, i.e. when it is determined that the flag F is at “1” (step S802: NO), it may be determined that one of the EGR abnormality diagnosis processing and the sensor abnormality diagnosis processing is underway. Therefore, to specify the abnormality diagnosis processing that is underway, a determination is made as to whether or not the sensor abnormality diagnosis processing is underway (step S807). In other words, a determination is made as to whether or not the sensor abnormality diagnosis processing having the higher order of precedence is underway. When it is determined that the sensor abnormality diagnosis processing is underway (step S807: YES), the series of processes is terminated and the sensor abnormality diagnosis processing that is underway continues to be executed.

On the other hand, when it is determined that the sensor abnormality diagnosis processing is not underway (step S807: NO), it may be determined that the EGR abnormality diagnosis processing having the lower order of precedence is underway. Therefore, a determination is made as to whether or not the execution condition of the sensor abnormality diagnosis processing that is not underway has been established (step S808). When it is determined that the execution condition of the sensor abnormality diagnosis processing is not established (step S808: NO), the series of processes is terminated and the EGR abnormality diagnosis processing that is underway continues to be executed.

On the other hand, when it is determined that the execution condition of the sensor abnormality diagnosis processing is established (step S808: YES), the EGR abnormality diagnosis processing that is currently underway is stopped (step S809). The abnormality diagnosis processing flag F is then set at “0” (step S810), whereupon the series of processes is temporarily terminated. Note that in this case, affirmative determinations are made respectively in the determination processing of the steps S801 to S803 of the next “abnormality diagnosis selection routine”, and therefore execution of the sensor abnormality diagnosis processing is permitted (step S804). Further, even when execution of the EGR abnormality diagnosis processing is permitted (step S806), if the execution condition of the sensor abnormality diagnosis processing is established (step S808: YES) in the next “abnormality diagnosis selection routine”, the EGR abnormality diagnosis processing that is underway is stopped (step S809).

According to the sixth embodiment described above, the actions and effects described below in (8) can be obtained in addition to actions and effects pursuant to the actions and effects described above in (1) to (6). (8) The order of precedence of the sensor abnormality diagnosis processing is set higher than the order of precedence of the EGR abnormality diagnosis processing, and therefore an abnormality in the oxygen concentration sensor 54, which is used in various types of control including the EGR abnormality diagnosis processing, can be determined preferentially.

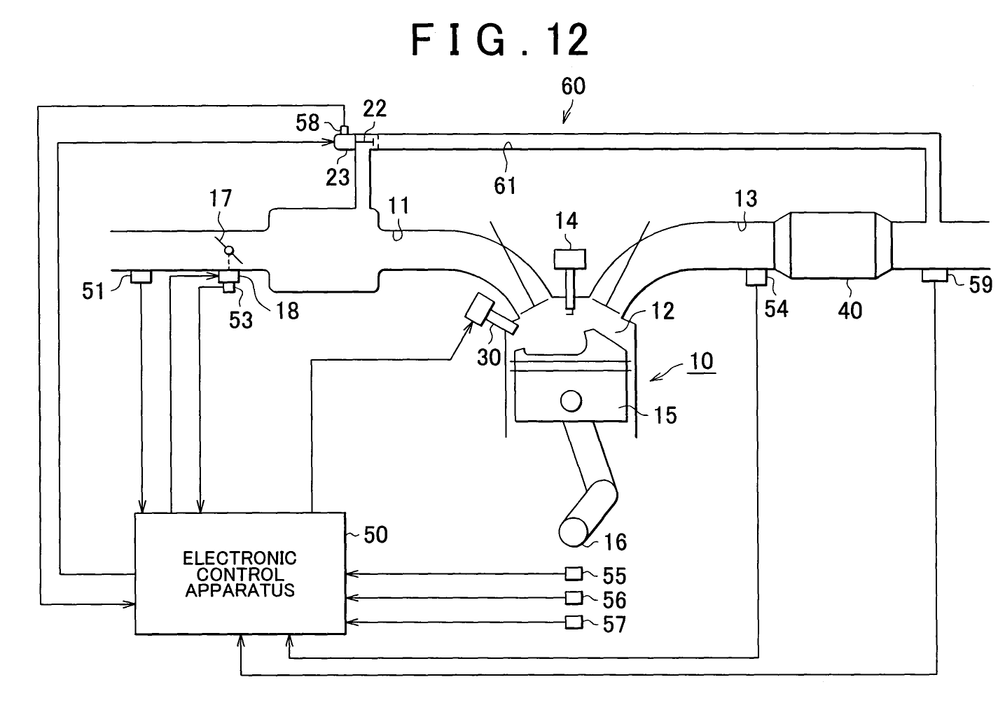

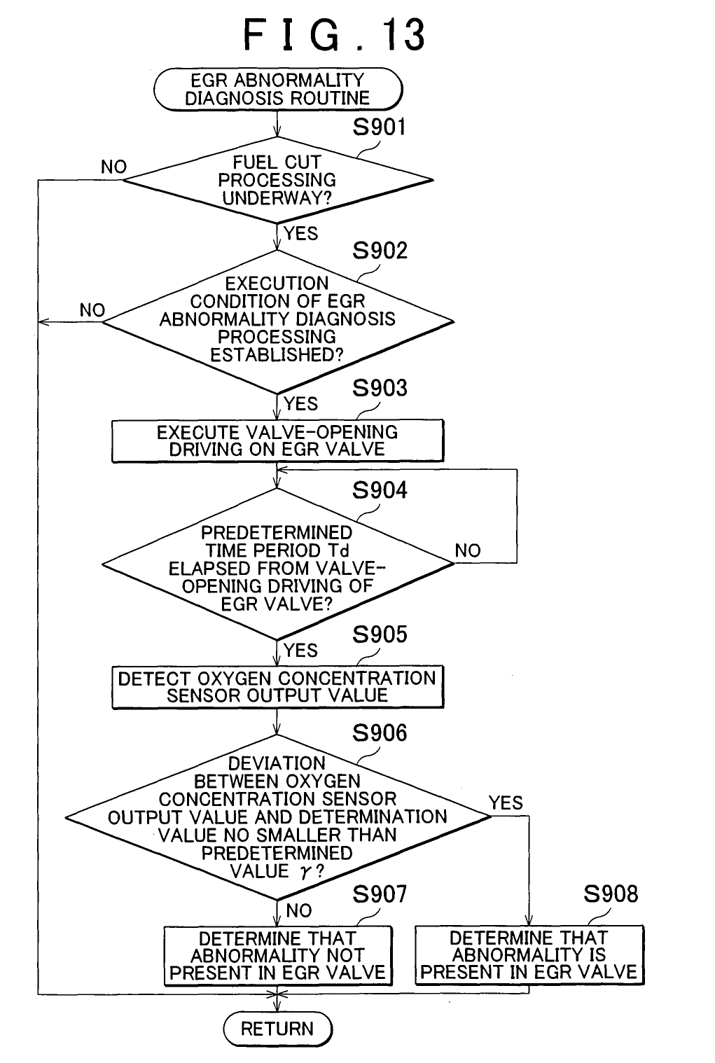

Referring to FIGS. 12 and 13, a seventh embodiment of the abnormality diagnosis apparatus for an exhaust gas recirculation apparatus according to the invention will be described specifically, focusing on differences with the first embodiment. Note that detailed description of similar constitutions and processes to those of the first embodiment described above has been omitted.

This embodiment differs from the first embodiment on the following points. In the first embodiment, the EGR apparatus 20 includes the EGR passage 21 for connecting the upstream side of the exhaust gas purification catalyst 40 in the exhaust passage 13 to the intake passage 11, and the EGR valve 22 for adjusting the amount of exhaust gas flowing through the EGR passage 21. In this embodiment, on the other hand, an EGR apparatus 60 having an EGR passage 61 for connecting the downstream side of the exhaust gas purification catalyst 40 in the exhaust passage 13 to the intake passage 11 and an EGR valve 22 for adjusting the amount of exhaust gas flowing through the EGR passage 61 is provided, as shown in FIG. 12. Note that apart from the location in which the EGR passage 21 or the EGR passage 61 is connected to the exhaust passage 13, the EGR apparatus 20 and the EGR apparatus 60 are constituted identically. In the EGR apparatus 60, a part of the exhaust gas is introduced into the intake passage 11 through the EGR passage 61 after passing through the exhaust gas purification catalyst 40, or in other words after being purified by the catalyst 40. Accordingly, the exhaust gas flows into the combustion chamber 12, enabling a reduction in the combustion temperature.

Furthermore, as shown in FIG. 12, in this embodiment a downstream side oxygen concentration sensor 59 is attached to the downstream side of the exhaust gas purification catalyst 40 in the exhaust passage 13. The downstream side oxygen concentration sensor 59 is a conventional concentration cell type oxygen sensor in which an output voltage thereof varies greatly when the air-fuel ratio of the exhaust gas is in the vicinity of the stoichiometric air-fuel ratio. More specifically, when the air-fuel ratio of the exhaust gas is richer than the stoichiometric air-fuel ratio, a voltage of approximately 1 V is output, and when the air-fuel ratio is leaner than the stoichiometric air-fuel ratio, the output voltage is substantially 0 V. The air-fuel ratio of the exhaust gas after passing through the exhaust gas purification catalyst 40 is detected on the basis of the output value of the sensor 59, whereby the purification condition of the exhaust gas component following purification by the exhaust gas purification catalyst 40 is learned. Thus, air-fuel ratio feedback control based on the output value of the oxygen concentration sensor 54 is corrected.

Further, in the “EGR abnormality diagnosis processing” of the first embodiment, an abnormality diagnosis is performed on the EGR valve 22 on the basis of the output value variation range of the oxygen concentration sensor 54 accompanying valve-opening driving of the valve 22. In the “EGR abnormality diagnosis routine” of this embodiment, on the other hand, an abnormality diagnosis is performed on the valve 22 on the basis of a deviation between the output value of the oxygen concentration sensor 54 and a determination value.

FIG. 13 is a flowchart showing the flow of a processing procedure of the “EGR abnormality diagnosis routine”. The actual processing is executed repeatedly by the electronic control apparatus 50 at predetermined periods. In this series of processes, first, a determination is made as to whether or not the fuel cut processing is underway (step S901). When it is determined that the fuel cut processing is not underway (step S901: NO), the series of processes is temporarily terminated.

On the other hand, when it is determined that the fuel cut processing is underway (step S901: YES), a determination is made as to whether or not the execution condition of the EGR abnormality diagnosis processing is established (step S902). More specifically, the execution condition is established when activation of the oxygen concentration sensor 54 is complete and the predetermined time period Ta has elapsed following the start of execution of the fuel cut processing, and similarly to the determination processing of the step S103 described above, a determination is made as to whether or not this condition has been established. When it is determined that the execution condition of the EGR abnormality diagnosis processing is not established (step S902: NO), the series of processes is temporarily terminated.

On the other hand, when it is determined that the execution condition of the EGR abnormality diagnosis processing is established (step S902: YES), valve-opening driving is executed on the EGR valve (step S903). A determination is then made as to whether or not a predetermined time period Td has elapsed following opening of the EGR valve (step S904). The predetermined time period Td is a period required for the exhaust gas that has accumulated in the EGR passage 61 to reach the oxygen concentration sensor 54 during the execution of valve-opening driving on the EGR valve 22, and is set in advance on the basis of a theoretical value or an experimental value, taking into consideration the volume and length of the EGR passage 61, the response speed of the EGR valve 22, the respective volumes of the combustion chamber 12 and the exhaust passage 13, the engine rotation speed, and so on.

When it is determined that the predetermined time period Td has not elapsed (step S904: NO), the determination processing of the step S904 is executed repeatedly at fixed intervals until a determination result according to which the predetermined time period Td has elapsed (step S904: YES) is obtained.

When it is determined through this determination processing that the predetermined time period Td has elapsed (step S904: YES), the output value of the oxygen concentration sensor at this time is detected (step S905).

A determination is then made as to whether or not the deviation between the detected output value of the oxygen concentration sensor and the determination value equals or exceeds a predetermined value γ (step S906). The determination value is an expected value of the output value of the oxygen concentration sensor 54 following the elapse of the predetermined time period Td when an abnormality has not occurred in the EGR valve 22 and the valve 22 has been opened appropriately in accordance with the valve-opening driving executed thereon, and is set in advance on the basis of a theoretical value or an experimental value, taking into consideration the volume of the EGR passage 61, the response speed of the EGR valve 22, variation caused by the engine operating conditions, and so on. In other words, when the EGR valve 22 is opened during execution of the fuel cut processing, the exhaust gas that has accumulated in the EGR passage 61 flows into the combustion chamber 12 in accordance with the opening of the valve 22, and therefore the oxygen concentration of the exhaust passage 13 decreases temporarily, causing the output value of the oxygen concentration sensor 54 to vary to the rich side. Of the oxygen concentration sensor 54 output value that varies to the rich side, the output value following the elapse of the predetermined time period Td after the EGR valve 22 is opened is preset as the determination value.

Further, the predetermined value γ is set in advance on the basis of an experiment or the like at a value at which it can be determined that an abnormality has occurred in the EGR valve 22. In other words, when an abnormality (for example, an operation defect in the EGR valve 22) occurs in the EGR apparatus 20, flow rate variation in the EGR passage 61 following opening of the EGR valve 22 diverges from the expected flow rate variation. As a result, the amount of variation in the oxygen concentration of the exhaust passage 13 following opening of the valve 22 diverges from the expected variation amount, leading to divergence between the output value of the oxygen concentration sensor 54 and the expected output value (the aforementioned determination value). Therefore, a minimum value of the deviation between the output value of the oxygen concentration sensor 54 and the determination value at which it is possible to determine that an abnormality has occurred in the EGR valve 22 is set as the predetermined value γ.

When it is determined through this determination processing that the deviation between the output value of the oxygen concentration sensor and the determination value does not equal or exceed the predetermined value γ, or in other words that the deviation is smaller than the predetermined value γ (step S906: NO), it may be determined that the exhaust gas in the EGR passage 21 has flowed into the intake passage 11 in accompaniment with the opening of the EGR valve 22 and then flowed through the exhaust passage 13, leading to variation in the oxygen concentration of the exhaust gas. In other words, it may be determined that the EGR valve 22 has been opened appropriately. Hence, it is determined that an abnormality has not occurred in the EGR valve (step S907), and the series of processes is terminated.

On the other hand, when it is determined that the deviation between the output value of the oxygen concentration sensor and the determination value is equal to or greater than the predetermined value γ (step S906: YES), it may be determined that the oxygen concentration of the exhaust gas in the exhaust passage 13 has not varied by the expected degree even though the EGR valve 22 is open. Hence, it is determined that an abnormality has occurred in the EGR valve (step S908), and the series of processes is terminated.

According to the seventh embodiment described above, the actions and effects described below in (9) can be obtained in addition to actions and effects pursuant to the actions and effects described above in (2) and (3). (9) When the fuel cut processing for halting the fuel supply of the internal combustion engine 10 is underway, the EGR valve 22 is opened, and when the deviation between the output value of the oxygen concentration sensor 54 and the determination value following driving of the valve 22 is equal to or greater than the predetermined value γ, it may be determined that an abnormality has occurred in the EGR apparatus 20. Hence, the presence of an abnormality in the EGR apparatus 20 can be determined accurately without providing a dedicated sensor for determining the presence of an abnormality in the EGR apparatus 20. Further, the presence of an abnormality in the EGR apparatus 20 is determined during the fuel cut processing, and therefore deterioration of the combustion condition in the combustion chamber 12 accompanying opening of the EGR valve 22 can be suppressed.

Note that the abnormality diagnosis apparatus for an exhaust gas recirculation apparatus according to the invention is not limited to the example constitutions described in the above embodiments, and these embodiments may be modified appropriately and implemented in the following forms, for example.

In the first to sixth embodiments, the determination as to whether or not the output value variation range of the oxygen concentration sensor is smaller than the predetermined value α (step S105, for example) is made in the following manner. Referring to the stored output value of the oxygen concentration sensor 54, the point in time at which the output value varies most greatly while the EGR valve 22 is open, or in other words the point in time at which deviation in the output value of the oxygen concentration sensor 54 reaches a maximum while the valve 22 is open, is learned, and the deviation at this time is learned as the output value variation range of the oxygen concentration sensor 54. This variation range is then compared to the predetermined value α to make the determination. However, the output value of the oxygen concentration sensor 54 following the elapse of a preset time period after valve-opening driving has been executed on the EGR valve 22 may be learned, and the deviation between the output value at this time and the output value at the opening timing of the EGR valve 22 may be learned as the variation range. Note that this time period corresponds to the predetermined time period Td described in the seventh embodiment.

In the first embodiment, an example in which the EGR valve 22 is opened following the elapse of the predetermined time period Ta from the start of the fuel cut processing was described. However, an aspect in which valve-opening driving is executed on the EGR valve 22 without measuring the elapsed time from the start of the fuel cut processing may be employed. In this case also, the output value of the oxygen concentration sensor 54, which varies to the lean side during the fuel cut processing, temporarily varies to the rich side when the valve 22 is opened normally, and therefore the EGR abnormality diagnosis processing can be executed in accordance with this fact. In this case also, the actions and effects described above in (1) and (3) can be obtained.

In the above embodiments, the oxygen concentration sensor 54 has a characteristic whereby the magnitude of the output signal (limiting current value) thereof varies linearly in a lean region and a rich region in accordance with the leanness (corresponding to the oxygen concentration) or the richness, and the EGR abnormality diagnosis processing is executed on the basis of the output value of the sensor 54. However, an oxygen concentration sensor that uses a different system may be employed as long as it outputs a continuous value corresponding to the oxygen concentration of the exhaust gas flowing through the exhaust passage 13. For example, an oxygen concentration sensor having a characteristic whereby the magnitude of the output signal (limiting current value) thereof varies linearly in a lean region only in accordance with the leanness may be employed.

Further, in the constitution shown in FIG. 1, an oxygen concentration sensor may also be provided on the downstream side of the exhaust gas purification catalyst 40, and the type of the oxygen concentration sensor provided on the downstream side may also be selected as desired.

In the second to sixth embodiments, examples in which an abnormality diagnosis is performed on the EGR valve 22 on the basis of the output value variation range of the oxygen concentration sensor 54 were described. However, an aspect in which an abnormality diagnosis is performed on the EGR valve 22 on the basis of the deviation between the output value of the oxygen concentration sensor 54 and the determination value, as described in the seventh embodiment, may be employed in each of these embodiments.

In the above embodiments, examples in which the presence of an abnormality, or in other words an operation defect, in the EGR valve 22 is determined were described. However, it may also be determined through the EGR abnormality diagnosis processing described in the above embodiments that an abnormality is present when a blockage occurs in the EGR passage 21, 61. More specifically, when a blockage occurs in the EGR passage 21, 61, exhaust gas does not flow through the EGR passage 21, 61 even when valve-opening driving is executed on the EGR valve 22, and therefore the output value of the oxygen concentration sensor 54 does not vary. Hence, it may be determined that an abnormality is present in the EGR apparatus 20, 60.

The sensor abnormality diagnosis processing described in the second to sixth embodiments is merely an example, and the invention is not limited to this example. More specifically, the invention may be applied to any processing for executing an abnormality diagnosis on an oxygen concentration sensor during fuel cut processing, including other conventional types of abnormality diagnosis processing performed on an oxygen concentration sensor.

While the invention has been described with reference to example embodiments thereof, it is to be understood that the invention is not limited to the described embodiments or constructions. To the contrary, the invention is intended to cover various modification and equivalent arrangements. In addition, while the various elements of the disclosed invention are shown in various example combinations and configurations, other combinations and configurations, including more, less, or only a single element, are also within the scope of the appended claims.

1. An abnormality diagnosis apparatus applied to an exhaust gas recirculation apparatus having an exhaust gas recirculation passage that connects an intake passage and an exhaust passage of an internal combustion engine in order to introduce a part of an exhaust gas into the intake passage and an exhaust gas amount control valve that adjusts an amount of the exhaust gas flowing through the exhaust gas recirculation passage, comprising:
an oxygen concentration sensor that is provided in the exhaust passage and outputs a continuous value corresponding to an oxygen concentration of the exhaust gas flowing through the exhaust passage; and
an EGR abnormality diagnosis unit that performs valve-opening driving on the exhaust gas amount control valve during fuel cut processing for halting a fuel supply of the internal combustion engine wherein at the start of the fuel cut processing, the valve is closed, and when the valve-opening driving is executed on the valve at a predetermined timing, executes abnormality diagnosis processing for determining that an abnormality is present in the exhaust gas recirculation apparatus when a variation range of an output value of the oxygen concentration sensor accompanying the valve-opening driving is smaller than a predetermined value.

2. An abnormality diagnosis apparatus applied to an exhaust gas recirculation apparatus having an exhaust gas recirculation passage that connects an intake passage and an exhaust passage of an internal combustion engine in order to introduce a part of an exhaust gas into the intake passage and an exhaust gas amount control valve that adjusts an amount of the exhaust gas flowing through the exhaust gas recirculation passage, comprising:
an oxygen concentration sensor that is provided in the exhaust passage and outputs a continuous value corresponding to an oxygen concentration of the exhaust gas flowing through the exhaust passage; and
an EGR abnormality diagnosis unit that performs valve-opening driving on the exhaust gas amount control valve during fuel cut processing for halting a fuel supply of the internal combustion engine, and executes abnormality diagnosis processing for determining that an abnormality is present in the exhaust gas recirculation apparatus when a deviation between an output value of the oxygen concentration sensor following the valve-opening driving and a determination value equals or exceeds a predetermined value.

3. The abnormality diagnosis apparatus for an exhaust gas recirculation apparatus according to claim 1, wherein the EGR abnormality diagnosis unit performs the valve-opening driving on the exhaust gas amount control valve on condition that respective interiors of a combustion chamber and the exhaust passage of the internal combustion engine have been filled with air.

4. The abnormality diagnosis apparatus for an exhaust gas recirculation apparatus according to claim 3, wherein the abnormality diagnosis unit determines that the respective interiors of the combustion chamber and the exhaust passage have been filled with air in accordance with an operating condition of the internal combustion engine.

5. The abnormality diagnosis apparatus for an exhaust gas recirculation apparatus according to claim 4, wherein the abnormality diagnosis unit uses an engine rotation speed as the operating condition of the internal combustion engine.

6. The abnormality diagnosis apparatus for an exhaust gas recirculation apparatus according to claim 1, wherein the EGR abnormality diagnosis unit determines that an abnormality is present in the exhaust gas recirculation apparatus on the basis of the output value of the oxygen concentration sensor following the elapse of a predetermined time period from the start of the valve-opening driving performed on the exhaust gas amount control valve.

7. The abnormality diagnosis apparatus for an exhaust gas recirculation apparatus according to claim 1, wherein the EGR abnormality diagnosis unit determines that an operation defect has occurred in the exhaust gas amount control valve as the abnormality in the exhaust gas recirculation apparatus.

8. The abnormality diagnosis apparatus for an exhaust gas recirculation apparatus according to claim 1, further comprising:
a sensor abnormality diagnosis unit that executes abnormality diagnosis processing for determining that an abnormality is present in the oxygen concentration sensor on the basis of the output value of the oxygen concentration sensor during the fuel cut processing; and
an abnormality diagnosis selection unit that selects one of the abnormality diagnosis processing performed by the EGR abnormality diagnosis unit and the abnormality diagnosis processing performed by the sensor abnormality diagnosis unit.

9. The abnormality diagnosis apparatus for an exhaust gas recirculation apparatus according to claim 8, wherein the abnormality diagnosis selection unit sets an order of precedence in relation to the abnormality diagnosis processing performed by the EGR abnormality diagnosis unit and the abnormality diagnosis processing performed by the sensor abnormality diagnosis unit, determines establishment of an execution condition of the abnormality diagnosis processing in accordance with the order of precedence, and permits execution of the abnormality diagnosis processing for which the execution condition is established.

10. The abnormality diagnosis apparatus for an exhaust gas recirculation apparatus according to claim 9, wherein, when the execution condition of the abnormality diagnosis processing having a higher order of precedence is established while the other abnormality diagnosis processing is underway, the abnormality diagnosis selection unit stops the abnormality diagnosis processing.

11. The abnormality diagnosis apparatus for an exhaust gas recirculation apparatus according to claim 9, wherein the abnormality diagnosis selection unit sets the order of precedence of the abnormality diagnosis processing performed by the sensor abnormality diagnosis unit to be higher than the order of precedence of the abnormality diagnosis processing performed by the EGR abnormality diagnosis unit.

12. The abnormality diagnosis apparatus for an exhaust gas recirculation apparatus according to claim 8, wherein, when the abnormality diagnosis processing performed by the EGR abnormality diagnosis unit is executed first during a period extending from the start to the completion of the fuel cut processing, the abnormality diagnosis selection unit permits the abnormality diagnosis processing performed by the sensor abnormality diagnosis unit after a predetermined time period has elapsed following stoppage of the abnormality diagnosis.

13. An abnormality diagnosis method for an exhaust gas recirculation apparatus having an exhaust gas recirculation passage that connects an intake passage and an exhaust passage of an internal combustion engine in order to introduce a part of an exhaust gas into the intake passage and an exhaust gas amount control valve that adjusts an amount of the exhaust gas flowing through the exhaust gas recirculation passage, comprising:
outputting a continuous value corresponding to an oxygen concentration of the exhaust gas flowing through the exhaust passage; and
performing valve-opening driving on the exhaust gas amount control valve during fuel cut processing for halting a fuel supply of the internal combustion engine wherein at the start of the fuel cut processing, the valve is closed, and, when the valve-opening driving is executed on the valve at a predetermined timing, determining that an abnormality is present in the exhaust gas recirculation apparatus when a variation range of an output value corresponding to the oxygen concentration of the exhaust gas flowing through the exhaust passage during the valve-opening driving is smaller than a predetermined value.

14. An abnormality diagnosis method for an exhaust gas recirculation apparatus having an exhaust gas recirculation passage that connects an intake passage and an exhaust passage of an internal combustion engine in order to introduce a part of an exhaust gas into the intake passage and an exhaust gas amount control valve that adjusts an amount of the exhaust gas flowing through the exhaust gas recirculation passage, comprising:
outputting a continuous value corresponding to an oxygen concentration of the exhaust gas flowing through the exhaust passage; and
performing valve-opening driving on the exhaust gas amount control valve during fuel cut processing for halting a fuel supply of the internal combustion engine, and determining that an abnormality is present in the exhaust gas recirculation apparatus when a deviation between an output value corresponding to the oxygen concentration of the exhaust gas flowing through the exhaust passage following the valve-opening driving and an expected value corresponding to an expected oxygen concentration following the elapse of a predetermined time period from the start of the fuel cut processing equals or exceeds a predetermined value.

15. The abnormality diagnosis apparatus for an exhaust gas recirculation apparatus according to claim 2, wherein the EGR abnormality diagnosis unit performs the valve-opening driving on the exhaust gas amount control valve on condition that respective interiors of a combustion chamber and the exhaust passage of the internal combustion engine have been filled with air.

16. The abnormality diagnosis apparatus for an exhaust gas recirculation apparatus according to claim 15, wherein the abnormality diagnosis unit determines that the respective interiors of the combustion chamber and the exhaust passage have been filled with air in accordance with an operating condition of the internal combustion engine.

17. The abnormality diagnosis apparatus for an exhaust gas recirculation apparatus according to claim 16, wherein the abnormality diagnosis unit uses an engine rotation speed as the operating condition of the internal combustion engine.

18. The abnormality diagnosis apparatus for an exhaust gas recirculation apparatus according to claim 2, wherein the EGR abnormality diagnosis unit determines that an abnormality is present in the exhaust gas recirculation apparatus on the basis of the output value of the oxygen concentration sensor following the elapse of a predetermined time period from the start of the valve-opening driving performed on the exhaust gas amount control valve.

19. The abnormality diagnosis apparatus for an exhaust gas recirculation apparatus according to claim 2, wherein the EGR abnormality diagnosis unit determines that an operation defect has occurred in the exhaust gas amount control valve as the abnormality in the exhaust gas recirculation apparatus.

20. The abnormality diagnosis apparatus for an exhaust gas recirculation apparatus according to claim 2, further comprising:
a sensor abnormality diagnosis unit that executes abnormality diagnosis processing for determining that an abnormality is present in the oxygen concentration sensor on the basis of the output value of the oxygen concentration sensor during the fuel cut processing; and
an abnormality diagnosis selection unit that selects one of the abnormality diagnosis processing performed by the EGR abnormality diagnosis unit and the abnormality diagnosis processing performed by the sensor abnormality diagnosis unit.

21. The abnormality diagnosis apparatus for an exhaust gas recirculation apparatus according to claim 20, wherein the abnormality diagnosis selection unit sets an order of precedence in relation to the abnormality diagnosis processing performed by the EGR abnormality diagnosis unit and the abnormality diagnosis processing performed by the sensor abnormality diagnosis unit, determines establishment of an execution condition of the abnormality diagnosis processing in accordance with the order of precedence, and permits execution of the abnormality diagnosis processing for which the execution condition is established.

22. The abnormality diagnosis apparatus for an exhaust gas recirculation apparatus according to claim 21, wherein, when the execution condition of the abnormality diagnosis processing having a higher order of precedence is established while the other abnormality diagnosis processing is underway, the abnormality diagnosis selection unit stops the abnormality diagnosis processing.

23. The abnormality diagnosis apparatus for an exhaust gas recirculation apparatus according to claim 21, wherein the abnormality diagnosis selection unit sets the order of precedence of the abnormality diagnosis processing performed by the sensor abnormality diagnosis unit to be higher than the order of precedence of the abnormality diagnosis processing performed by the EGR abnormality diagnosis unit.

24. The abnormality diagnosis apparatus for an exhaust gas recirculation apparatus according to claim 20, wherein, when the abnormality diagnosis processing performed by the EGR abnormality diagnosis unit is executed first during a period extending from the start to the completion of the fuel cut processing, the abnormality diagnosis selection unit permits the abnormality diagnosis processing performed by the sensor abnormality diagnosis unit after a predetermined time period has elapsed following stoppage of the abnormality diagnosis.
